(19) United States
(12) Patent Application Publication
(10) Pub. No.: US 2024/0428082 A1
(43) Pub. Date: Dec. 26, 2024

(54) EFFICIENT RECOVERY FROM FAILURES DURING DISTRIBUTED TRAINING OF MACHINE LEARNING MODELS

(71) Applicant: Amazon Technologies, Inc., Seattle, WA (US)

(72) Inventors: Zhuang Wang, Kirkland, WA (US); Zhen Jia, San Jose, CA (US); Shuai Zheng, Santa Clara, CA (US); Zhen Zhang, Santa Clara, CA (US); Xinwei Fu, Fremont, CA (US); Yida Wang, Palo Alto, CA (US)

(73) Assignee: Amazon Technologies, Inc., Seattle, WA (US)

(21) Appl. No.: 18/491,604

(22) Filed: Oct. 20, 2023

Related U.S. Application Data
(60) Provisional application No. 63/509,500, filed on Jun. 21, 2023.

(51) Int. Cl. G06N 3/098

(52) U.S. Cl. CPC G06N 3/098

(57) ABSTRACT

A placement plan for training state checkpoints of a machine learning model is generated based at least in part on a number of training servers of a distributed training environment. The plan indicates, with respect to an individual server, one or more other servers at which replicas of training state checkpoints of the individual server are to be stored. During selected periods of one or more training iterations of the model, respective portions of a replica of a training state checkpoint of a first server are transmitted to a second server selected based on the placement plan. After an event causes disruption of the training iterations, one of the checkpoints generated at the first server is retrieved from the second server and used to resume the training iterations.

This application claims benefit of priority to U.S. Provisional Application No. 63/509,500 filed Jun. 21, 2023, titled “Cloud-based Managed Services For Foundation Models And Associated Applications,” which is hereby incorporated by reference in its entirety.

### BACKGROUND

Large-scale machine learning models are being developed and deployed for a variety of applications. For example, generative artificial intelligence (GAI) models such as large language models (LLMs) with millions or even billions of parameters are trained to conduct intelligent searches, participate in multi-turn conversations, and so on. The training of such models can take large amount of input data, numerous machines and long periods of time. As in most large distributed systems, various types of failures or errors can occur during the training of the models—for example, hardware failures can occur at some of the machines or within the network connecting the machines. In some cases training disruptions caused by such events can result in substantial wastage of time and resources.

### BRIEF DESCRIPTION OF DRAWINGS

FIG. 1 illustrates an example system environment in which, to enable quick recovery from failures during the training of machine learning models at distributed training environments, a checkpointing technique for training state information may be implemented using a hierarchy of storage devices, according to at least some embodiments.

FIG. 2 illustrates example components of servers which may be used for computations performed during distributed training of machine learning models, according to at least some embodiments.

FIG. 3 illustrates an example set of factors which may contribute to wasted time when failures are encountered during training of a machine learning model for which checkpoints of training state information are stored periodically, according to at least some embodiments.

FIG. 4 illustrates an example hierarchy of devices which may be used for storing model training state checkpoint contents.

FIG. 5 illustrates an example architecture for enabling efficient checkpoint-based recovery from failures in a distributed training environment, according to at least some embodiments.

FIG. 6 illustrates example types of placement plans which may be employed for storing replicas of training state checkpoints at distributed training environments, according to at least some embodiments.

FIG. 7 is a flow diagram illustrating aspects of example operations that may be performed to create and implement a placement plan for replicas of training state checkpoints, according to at least some embodiments.

FIG. 8 illustrates an example methodology in which consolidated transfers of training state checkpoint data may be performed at the ends of training iterations, according to at least some embodiments.

FIG. 9 illustrates an example methodology in which transfers of training state checkpoint data may be scheduled during time periods in which the rate of training traffic is low, according to at least some embodiments.

FIG. 10 illustrates an example methodology in which transfers of training state checkpoint data from a destination training accelerator's memory to main memory of the corresponding training server are performed after all the checkpoint state data being transferred to the destination training accelerator during a low-training-communication time period has been received, according to at least some embodiments.

FIG. 11 illustrates an example methodology in which transfers of training state checkpoint data from a destination training accelerator's memory at a training server to main memory of that training server are performed in parallel with transfers of checkpoint data to the destination training accelerator, according to at least some embodiments.

FIG. 12 is a flow diagram illustrating aspects of example operations that may be performed to partition training state checkpoint data for efficient transfers between training accelerators at respective training servers, according to at least some embodiments.

FIG. 13 is a flow diagram illustrating aspects of example operations that may be performed to create training state checkpoints at several levels of a storage hierarchy, and utilize checkpoints from selected levels to respond to training disruptions, according to at least some embodiments.

FIG. 14 illustrates example programmatic interactions associated with the creation and use of training state checkpoints, according to at least some embodiments.

FIG. 15 illustrates an example provider network at which a machine learning service may be implemented, according to at least some embodiments.

FIG. 16 is a block diagram illustrating an example computing device that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof. Unless otherwise explicitly stated, articles such as “a” or “an” should generally be interpreted to include one or more described items throughout this application. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set” and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

### DETAILED DESCRIPTION

The present disclosure relates to methods and apparatus for efficient checkpoint-based recovery from failures which can occur during the training of machine learning models at large-scale distributed training environments. Some machine learning (ML) models are trained using groups of hundreds or even thousands of interconnected training servers concurrently, with each training server in turn comprising numerous hardware training accelerators (HTAs) (such as graphics processing units (GPUs)) optimized for performing training-related computations. Often, such large models are trained using resources of a cloud provider network or cloud computing environment, including, for example, training servers (TSs) acquired from computing services of the cloud computing environment (such as a virtualized computing service or VCS) as well as training coordinators of a machine learning service (MLS) of the cloud computing environment. The training of an ML model typically comprises numerous iterations, which can collectively take a substantial amount of time (e.g., weeks or months for large models with millions or billions of parameters). In some scenarios in which the model comprises a neural network, a training iteration can include computations of a forward pass through the neural network with respect to a given subset or batch of input data, followed by a backward pass, and a parameter update phase. Training state information comprising updated values of the parameters (e.g., learned weights), as well as optimizer states of the model, can be transferred or exchanged among the HTAs via a network, for example after the forward and backward passes are complete. A given HTA can include its own memory, referred to as accelerator memory, separate from the main memory of the TS to which the HTA belongs.

Various types of errors or failures can disrupt model training in a distributed training environment (DTE) at any time during or between training iterations—for example one or more HTAs can fail, one or more TSs can fail, network connectivity among a subset of the TSs or HTAs can be lost, software errors can occur, and so on. In order to handle such disruptive events, many conventional systems create checkpoints of the model's training state periodically (e.g., after every N iterations, where N is a parameter) and store them at remote storage devices. In a scenario in which the model is being trained using resources of a computing service of a cloud computing environment, storage devices such as solid state drives (SSDs) or magnetic disks of a storage service separate from the computing service can be used to store the checkpoints. A given training state checkpoint of the model as a whole can comprise (for example) the current values of the model's learnable parameters (such as weights), optimizer states, learning rates and the like, which are initially computed/generated at the various HTAs being used for the training, and initially stored within accelerator memories. If and when a disruptive event is detected, the failure or error can be repaired if needed (for example, a new TS can be provisioned and deployed in place of a failed TS), and the most recent saved training state checkpoint can be retrieved to enable the training process to be resumed, starting from the training state captured in that checkpoint. Unfortunately, in some cases the speed with which training state checkpoints can be transferred between the TSs and the remote storage may be such that a substantial amount of training time and resources are wasted. The amount of training state data can be quite large (e.g., several gigabytes per accelerator for some ML models), and the network bandwidth available between the TSs and the remote storage can sometimes be low relative to the bandwidth available for communications among the HTAs at different TSs. Note that in general, the training state information of the model as a whole can comprise the combination of training state information generated at the various HTAs being used for the training.

To help reduce the wasted time, a hierarchical checkpointing algorithm that makes use of several kinds of memory and storage, instead of using only remote storage devices, can be implemented according to the techniques introduced herein. The proposed technique is motivated at least in part by empirical evidence which suggests that in many cases (a) the main memory of a TS is large relative to the sum of the sizes of the accelerator memories of the HTAs of the TS and (b) during training of an ML model using the HTAs, enough unused main memory is available at the TS to store training state data generated collectively at the HTAs of several TSs. Because much of the computation required for training is done using the HTAs and the HTA memories, the fraction of the main memory of a TS which is available/unused during model training can be relatively high (compared for example to scenarios in which the TS is utilized mainly for other types of applications which tend to utilize the central processing units [CPUs] of the TS more than the HTAs of the TS).

According to the proposed technique, replicas of training state checkpoints of a given TS (comprising training state information aggregated from all the HTAs of that TS) of a DTE can be stored fairly frequently (once every iteration, or once every few iterations) at the main memories of some number of the DTE's other TSs, for example in addition to transferring the training state information of the model as a whole to remote storage at a lower frequency. The simpler term “checkpoint” may be used synonymously herein with the phrase “training state checkpoint”.

At the main memory of a given TS, a local checkpoint comprising state information collected from the HTAs within that TS itself can be stored in some cases, e.g., to help with recovery from software errors/failures. Such training state checkpoints can be referred to as server-level or TS-level checkpoints, e.g., as they comprise training state aggregated from, or derived from, numerous HTAs of a given TS. In addition, one or more replicas of the contents of a local server-level checkpoint can be transferred to one or more other TSs via a fast network interconnect (and if and when needed for recovery, retrieved quickly from those other TSs). The specific other TSs at which the replicas are stored can be chosen in accordance with a placement plan or strategy generated at, and/or implemented by, a component of an MLS, such as a training coordinator comprising one or more computing devices. The placement plan can help ensure that the distributed training environment is able to recover from (i.e., resume training iterations fairly quickly after) a selected number of training disrupting events of one or more categories (e.g., TS failures, HTA failures, etc.) without having to resort to using checkpoints stored at remote storage devices. Note that for recovery from some types of severe disruptive events (such as near-concurrent failures at numerous TSs), the checkpoints stored at the remote storage can still be used; however, for most commonly-experienced types of disruptions, checkpoints which can be retrieved much more quickly than the checkpoints stored at the remote storage devices can be used.

For transferring replicas of the checkpoints from one TS to another, any of several kinds of network paths provided by the DTE between the TSs can be utilized. In some distributed training architectures, distinct network links or paths may be available for optimized (e.g., high-speed) HTA-to-HTA communication between individual HTAs at different TSs. In scenarios in which optimized HTA-to-HTA network links are available, checkpoint contents can be transferred directly between pairs of HTAs (e.g., with one HTA being the source of a portion of a replica of a server-level checkpoint at one TS, and another HTA being chosen as the destination of that portion of the replica at a different TS). After checkpoint contents are received at the destination HTA and stored initially within that HTA's memory, the contents can be transferred to the main memory of the destination HTA's TS. In other scenarios, the contents of the checkpoints can instead be transferred from the main memory of one TS to the main memory of another TS. Similarly, for transferring training state information between TSs and remote storage devices, in some cases direct transfers from the HTAs to remote storage can be used, while in other cases the state information can be copied from the TS main memories to the remote storage devices.

The inter-TS or inter-HTA network paths are used for a certain amount of baseline training-related traffic, separate from the transfer of checkpoints. For example, in some cases involving neural network models, the network paths between HTAs may be used at some stage of a forward pass, again at some stage of a backward pass, and/or during the parameter updating stage, regardless of whether checkpoint contents are being transferred or not. As such, the checkpoint-related network traffic between TSs can be considered an overhead on top of the baseline training-related network traffic. At least for some types of distributed training algorithms, the baseline training-related traffic typically occurs in fairly predictable patterns, often with substantial “idle periods” or “bubbles” between various stages of training-related network transfers. Such idle periods or bubbles can be referred to as low-training-communication periods (LTCs), e.g., to distinguish them from the time periods in which the network links are preferably used primarily for the training-related traffic.

If the transfer of checkpoint contents delays or interferes with the baseline training-related traffic, this can slow down the training process, potentially to an unacceptable extent. In order to avoid such slowdowns, a pipelined partitioning plan can be generated and employed, which takes advantage of the empirically observed patterns of LTCs. First, the baseline training-related traffic patterns of the model can be analyzed for a few initial training iterations, during which checkpoints are not created. Based on this analysis, probabilistic predictions of LTCs (i.e., when, during a training iteration relative to the start of the iteration, one or more LTCs are likely or expected to begin and end) within future training iterations can be generated. According to the pipelined partitioning plan, the total amount of training state data which is to be transferred from one HTA to another HTA over a network for a given checkpoint can be subdivided into chunks. The sizes of the chunks can be selected such that most of (or all of) the chunks can be transferred during LTCs, thereby minimizing interference with the baseline training traffic. Furthermore, HTA memory being used to store the checkpoint at the source HTA and the destination HTA can be divided into smaller units or buffers, with checkpoint data of one unit being transferred over the network at a time. Such memory subdivision can enable parallelism between the over-the-network unit-at-a-time transfers of checkpoint data, and the transfers between the HTA memory and the main memory of the TS of the destination HTA. As such, using the techniques introduced herein, the transfer of checkpoint state information can be accomplished in a pipelined fashion, with minimal interference between checkpoint-related traffic and baseline training-related traffic, and with transfers between HTA memory of a destination HTA and main memory of the destination HTA's TS being conducted while additional checkpoint data is received concurrently. Parameters of the placement plan and the pipelined partitioning plan can be selected by an MLS in some cases, e.g., based on desired levels of recovery performance indicated by customers and/or based on properties of the models being trained.

As one skilled in the art will appreciate in light of this disclosure, certain embodiments may be capable of achieving various advantages, including some or all of the following: (a) substantially reducing the amount of time and resources taken to complete training of a model at a distributed training environment when failures or other disruption events occur during the training, (b) arranging the timing of transfers of training state checkpoints among various levels of a storage hierarchy in such a way that the impact of the checkpoint-related operations on baseline training operations is minimized and (c) in scenarios in which the techniques introduced herein are implemented at a cloud computing environment, enabling customized levels of recovery performance to be supported for different models and different customers of the cloud computing environment. Note that the techniques introduced herein can be employed successfully for numerous types of distributed training algorithms, including algorithms which employ data parallelism, model parallelism, tensor parallelism, or a combination of different kinds of parallelism. In addition, the benefits of the techniques outlined herein can be accrued for a wide variety of models, including but not limited to GAI models such as LLMs, image/video analysis models, multimedia analysis models, and the like. Furthermore, the benefits of the techniques introduced herein, relative to some conventional techniques for handling training disruptions, may increase as the size of the distributed training environment and/or the complexity or size of the model being trained increases.

According to some embodiments, a system may include one or more computing devices. The one or more computing devices may include instructions that upon execution on or across the one or more computing devices implement a training coordinator (TC) of an MLS of a cloud provider network. The TC may be configured to orchestrate the training of various types of models using cloud-based distributed training environments. In at least some embodiments the TC may also be responsible for at least some of the work required to detect and/or respond to training disrupting events such as hardware failures, software errors and the like. In various embodiments, the TC may itself be a distributed entity comprising respective subcomponents or elements run at respective training servers and other resources.

In some embodiments, a TC may determine a number of TSs of a DTE which is to be used to train a particular ML model on behalf of a customer or client of the MLS. A given TS may include a main memory and one or more HTAs, e.g., in addition to other components such as one or more CPUs and the like. Individual ones of the HTAs may comprise respective HTA memories in various embodiments, distinct from the main memory of the TS. Training of the ML model may comprise a sequence of training iterations. During a given iteration, respective subsets of training state information of the model (such as current learnable parameters, optimizer states, learning rates, etc.) may be stored at least initially within respective ones of the HTA memories. The TC may determine a number of replicas of training state checkpoints of the model, aggregated at the TS level, that are to be stored within respective main memories of one or more TSs. A given checkpoint may comprise training state information which was stored initially at HTA memories of several or all the HTAs of an individual TS. HTA memory may also be referred to herein as accelerator memory, and the checkpoints aggregated from the HTAs of a TS may also be referred to as server-level checkpoints or TS-level checkpoints. In some embodiments, a global or full checkpoint of the model, corresponding to the collection of state information of the model as a whole as of a particular iteration, may comprise contents of several or all of the TS-level checkpoints created for that iteration.

The TC may generate, based at least in part on the number of replicas and the number of TSs of the DTE, a placement plan or strategy for the TS-level checkpoints in various embodiments. Any of several types of placement plans may be generated in different embodiments, such as a group-based placement plan (GPP), a ring-based placement plan (RPP), or a hybrid or mixed placement plan (MPP) which combines aspects of a GPP and an RPP. In at least some embodiments, the generated placement plan may divide the TSs of the DTE into groups, such that an individual group includes a plurality of TSs. The placement plan may indicate, with respect to a particular TS within a particular group, one or more other TSs of the particular group at which respective replicas of server-level checkpoints of the particular TS are to be stored in main memory.

The TC may initiate training iterations of the ML model using the TSs of the DTE. Based at least in part on analysis of network communications among a plurality of HTAs of the DTE during selected training iterations, a prediction of respective timings of one or more low-training-communication periods (LTCs) during subsequent training iterations may be obtained in various embodiments. In some embodiments, the TC may generate the predictions itself; in other embodiments, a tool or program separate from the TC may be used. During an LTC predicted for a given pair of HTAs HTA-1 and HTA-2 with respect to a training iteration TI-1, where HTA-1 is incorporated within a TS TS-1 and HTA-2 is incorporated within a different TS TS-2, the volume of baseline training-related network traffic between HTA-1 and HTA-2 may be lower than during other periods of TI-1. In some cases, one or more LTCs may be predicted to include no baseline training-related traffic; in other cases, one or more LTCs may include a small amount of baseline training-related traffic, but the volume or rate of such traffic may be expected to be much lower than the peak volume or rate of baseline training-related traffic during the corresponding iteration. As indicated earlier, the baseline training-related traffic refers to network traffic that would typically be required between HTAs at different TSs during the training iterations in scenarios in which no checkpoints were being created or transferred between the TSs. In at least some embodiments, the patterns and timings of baseline training-related traffic (and hence the pattern and timings of LTCs) may be fairly similar, or at least predicted to be fairly similar, in different training iterations of a given model. As such, LTCs may be expected to start at roughly similar times relative to the start of any given iteration, and to last for roughly the same amounts of time in different iterations. In some cases, a given LTC within a given iteration may differ in duration from one or more other LTCs within that same iteration.

Having obtained the predictions of the LTCs, the TC may start scheduling transfers of checkpoint contents during the LTCs in various embodiments, e.g., so as to minimize interference with the expected baseline training-related network traffic. For example, transmission of respective portions or chunks of a checkpoint from an HTA at one TS to an HTA at another TS (with the other TS being selected according to the placement plan generated earlier) may be scheduled within respective predicted LTCs. A plan for partitioning the checkpoint data into chunks, such that a given chunk can in most cases be transferred within a given LTC may be generated in some embodiments when the LTC predictions can be obtained. Such a partitioning plan may be referred to as a pipelined partitioning plan or strategy. In some embodiments, statistical metrics such as coefficients of variances of the observed LTCs across different iterations which were analyzed to help generate the predictions may also be used in the generation of the pipelined partitioning plan. In general, in various embodiments, the TC may take inter-iteration variations in LTCs, as well as intra-iteration variations in LTCs, into account when scheduling transfers of the checkpoint chunks.

An event which results in the disruption of the training of the ML model may occur at some point during the training process in various embodiments. After such an event is detected, and (depending on the nature of the event) any needed hardware replacement tasks are completed, the training iterations of the model may be resumed using at least a particular replica of a checkpoint that was transmitted from one TS to another in accordance with the placement plan and the LTC-based scheduling of checkpoint transfers.

In at least one embodiment, in addition to transferring replicas of checkpoints created at a given source TS (e.g., by combining training state information of the TS's HTAs) at other TSs which can be referred to as destination TSs, a local copy of a checkpoint may be stored in the main memory of the source TS as well. Such local checkpoints can be used to rapidly recover from some types of training disrupting events, such as software errors, which do not involve loss of access to the source TS's main memory.

A portion or subset of an HTA's memory may be reserved in some embodiments for storing checkpoint contents (e.g., locally-generated checkpoint contents which are to be transferred to another HTA, and/or checkpoint contents received from some other HTA in accordance with the placement plan). The unreserved portion of the HTA memory may for example be used for baseline training tasks. In some implementations, the subset of HTA memory may be further subdivided into two or more sub-units or buffers. The contents of individual buffers comprising locally-generated checkpoint contents may be transferred one buffer at a time to remote HTAs (e.g., if there are two buffers B1 and B2, the transfer of contents of B1 may be completed from the perspective of the source HTA before beginning transfer of contents of B2). Such step-wise transfer may enabling optimizations such as parallelism between HTA-to-main-memory transfers and HTA-to-HTA transfers. For example, after the contents of a first buffer B-source-1 of a source HTA are received and stored within a buffer B-destination-1 at a destination HTA of the transfer, contents of B-destination-1 may be transferred to the main memory of the TS of the destination HTA, while contents of a second buffer B-source-2 may concurrently be received and stored in a buffer B-destination-2.

In at least some embodiments, a collection of training state information of the model may also be stored at remote storage devices (e.g., in addition to storing checkpoints in local main memories at TSs and in main memories of other TSs). A remote storage checkpointing rate may be selected, e.g., by a TC, and used to schedule such transfers. Such a collection of training state information may be referred to as a global or full checkpoint in some embodiments, and may comprise contents of several TS-level checkpoints corresponding to a given training iteration. In at least some embodiments, the remote storage checkpointing rate may be selected in such a way that training state information is transferred less frequently to remote storage than the rate at which TS-level checkpoints are created and replicated. When some types of training disruption events occur, from which recovery using TS-level checkpoints cannot be accomplished, the most recently transferred collection of training state information may be retrieved from the remote storage, and used to resume training iterations of the model.

In embodiments in which the checkpoint techniques introduced above are implemented at an MLS, customers of the MLS on whose behalf the models are being trained may provide input (e.g., via MLS programmatic interfaces) about various parameters of the checkpoint techniques. For example, a customer may provide a descriptor the model (e.g., indicating that the model is an LLM with P parameters), the number of TSs to be used for the model, the number of replicas of checkpoints which are to be created, the frequency/rate at which TS-level checkpoints are to be created and replicated (e.g., once every iteration, or once every K iterations), and so on. In other embodiments, the MLS may generate recommendations for values of various parameters used in the checkpoint creation and replication, such as the number of replicas which should be created and propagated at the TSs, and obtain approval from the customer (or parameter values chosen by the customer instead of the recommended values) before starting the training iterations.

In some embodiments, individual training servers of the DTE may comprise one or more virtual machines or compute instances of a virtualized computing service of a cloud provider network or cloud computing environment. In other embodiments in which the checkpoint plans are generated and implemented by an MLS of a cloud computing environment, at least some TSs of the DTE may be located at premises external to the data centers of the cloud computing environment, e.g., at premises of the customers on whose behalf the models are to be trained. In one embodiment, an HTA may comprise one or more GPUs. In other embodiments, an HTA may comprise one or more processors or chip sets (other than conventional GPUs) that have been customized and/or optimized for machine learning computations.

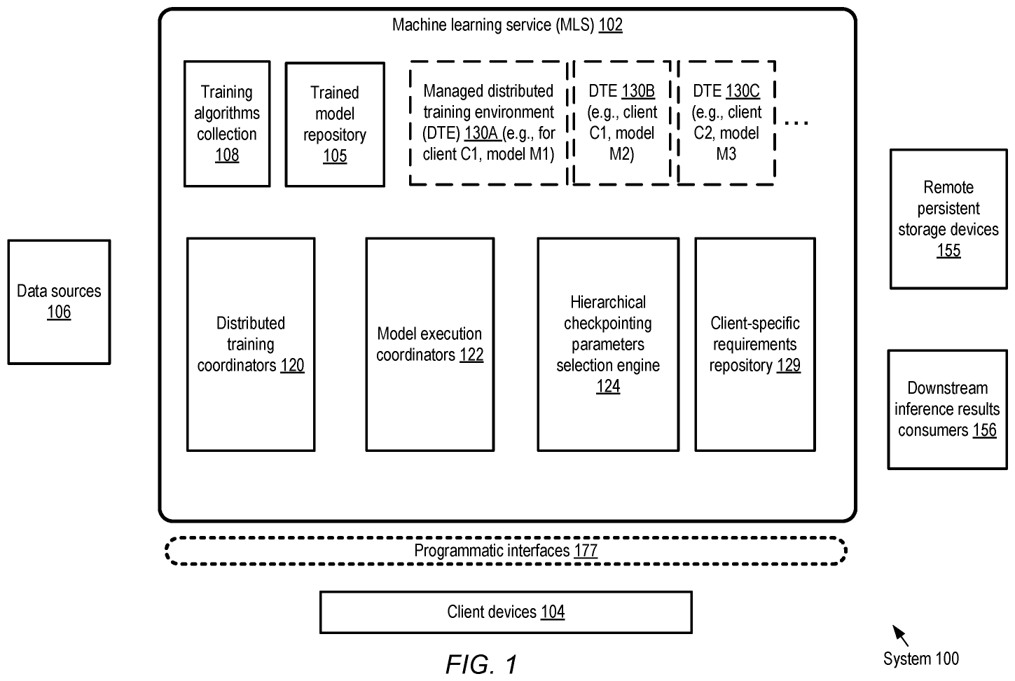

FIG. 1 illustrates an example system environment in which, to enable quick recovery from failures during the training of machine learning models at distributed training environments, a checkpointing technique for training state information may be implemented using a hierarchy of storage devices, according to at least some embodiments. As shown, system 100 may include resources and artifacts of an MLS 102, including distributed training coordinators 120, model execution coordinators 122, hierarchical checkpoint parameters selection engine 124, client-specific requirements repository 129, training algorithms collection 108, and a trained model repository 105. Individual ones of these subcomponents may be implemented using some combination of hardware and software of one or more computing devices. In some embodiments the MLS may be one of a suite of network-accessible services of a cloud provider network or cloud computing environment. The MLS may implement a set of programmatic interfaces 177 in the depicted embodiment, such as web-based consoles, graphical user interfaces, command-line tools, application programming interfaces (APIs), and the like, which may be used by customers or clients of the MLS to submit various kinds of ML-related requests and messages, and receive corresponding responses. In much of the following description, the example models whose training and recovery from training disruptions is being described are assumed to comprise neural networks; however, it is noted the checkpoint-related techniques introduced herein are not limited to any particular model architectures or structures.

Using programmatic interfaces 177, a customer may submit various requests from client devices 104 (such as desktops, laptops, mobile computing devices, and the like) pertaining to the training of one or more models using algorithms from collection 108 at respective distributed training environments managed by the MLS in the depicted embodiment. A managed distributed training environment (DTE) such as DTE 130A, DTE 130B, or DTE 130C may comprise several training servers or TSs (not shown in FIG. 1) at which the computations of the training process may be performed, e.g., using training data obtained from one or more data sources 106. For example, DTE 130A may be set up (e.g., by a subcomponent of a distributed training coordinator 120) to train model M1 on behalf of client C1 of the MLS, DTE 130B may be set up to train a different model M2 on behalf of client C1, and DTE 130C may be established to train a model M3 for a client C3. In various embodiments, at least some of the TSs may comprise a respective set of HTAs, with many or all of the training computations being performed using processors of the HTAs rather than using the CPUs of the TSs. Individual HTAs may comprise respective accelerator memories, separate from the main memories or CPU-accessible memories of the TSs. At least some state information of the model which is being trained (such as current values of learnable parameters, optimizer states, learning rates, etc.) may initially be computed and stored at accelerator memories in the depicted embodiment, e.g., instead of at the main memories of the TSs.

For some models, the DTE may comprise numerous (e.g., hundreds or even thousands of) TSs interconnected via high-bandwidth low-latency network links. In some cases, the network links may enable fast direct transfers of data from accelerator memories at one TS to accelerator memories at other TSs. As in many large distributed computing configurations, errors or failures may occur at individual TSs of a DTE, and/or in the network paths linking the TSs or their accelerators to one another. Some of the errors or failures may disrupt or prevent the continuation of training of the model. For example, for some types of distributed training algorithms, recovery from a failure of one of the TSs during a given training iteration TI-j may require (a) the replacement of the failed TS followed by (b) re-synchronization of the state information of the model at all the TSs (including the replacement TS) to the state as of a particular earlier-completed training iteration, before training can be resumed. Depending on the iteration whose state information is used for the re-synchronization, the training iterations may be resumed starting at TI-(j−1) (the iteration immediately prior to TI-j), or starting at an earlier iteration. Some such training algorithms, which are used frequently for large models including LLMs in industrial settings, may be referred to as static synchronous training algorithms with a fixed-size set of computation resources.

To help with recovery after training disruptions, checkpoints of model training state information can be created at various granularities and stored at various types of memory or storage devices. Such checkpoints may be retrieved, as needed, from the devices where they are stored to the TSs where they are to be used to synchronize the training state information after a disruption of the training iterations. A given checkpoint may for example include, as of the time or iteration number at which the checkpoint was created, the currently-learned parameter values, the current optimizer states, the current learning rates, and so on. In various implementations, a given checkpoint may comprise one or more collections of vectors, matrices or tensors of floating point and/or integer values, a set of scalar values, metadata (such as an iteration number) associated with the values, and so on. Generally speaking, training state information of the model may be used to create checkpoints of various sizes and granularities—e.g., accelerator-level checkpoints may represent the portion of model training state which is available at a single accelerator, TS-level checkpoints may include or be derived from contents of accelerator-level checkpoints at a given TS, and global or full checkpoints may include contents of many or all server-level checkpoints of a DTE.

In the embodiment depicted in FIG. 1, a hierarchical replicated checkpointing technique that makes used of several types of memory/storage with differing retrieval performance characteristics (i.e., speeds at which state information can be retrieved) may be implemented. Such a memory/storage hierarchy can include HTA memories, local main memories of the TSs at whose HTAs the state information is initially computed/generated, main memories of other TSs which can be accessed via network interconnects, and/or remote persistent storage devices 155 (e.g., devices provided by storage services of a cloud provider network) in various embodiments. Within such a hierarchy, speeds of data retrieval (e.g., to an accelerator memory) may be fastest from local main memories, somewhat slower from main memories of other TSs, and slowest from remote storage devices. When checkpoint contents are to be retrieved for synchronization after a training disruption, one or more sources from which those checkpoint contents can be retrieved quickly (which can vary, depending on the nature of the event that led to the disruption) may be identified or selected by a distributed training coordinator 120. The checkpoint contents may then be quickly retrieved from the selected source or sources, the model state can be synchronized using those contents at all the TSs, and training iterations can be resumed, starting from the state to which the model was synchronized.

To make the recovery process more robust, replicas of individual checkpoints may be stored within respective main memories of multiple TSs in various embodiments, thereby increasing the probability that at least some main memory based checkpoints can be retrieved from some TS instead of having to rely on checkpoints stored at remote storage devices. A placement plan may be generated, e.g., by a distributed training coordinator using a hierarchical checkpointing parameters selection engine 124, to identify the particular set of TSs at which a given checkpoint should be replicated. Details of the manner in which such placement plans are created in different embodiments are provided below.

During the training iterations of a given model, in which computations are performed at various hardware accelerators of the TSs of a given DTE, a baseline amount of training-related network traffic may be generated between various pairs of TSS (e.g., between accelerators at different TSs). Such training-related network usage may be a function of the kind of training algorithm which is being employed, and may be required regardless of whether checkpoints are being generated or not. The network pathways used for such training-related communication may be the same pathways which are used to transfer replicas of checkpoints. As a result, it could sometimes be the case that checkpoint-related traffic interferes with, and hence delays, the baseline training-related required traffic. Such delays of the baseline traffic may result in slowing down training as a whole, and may therefore be undesirable in various embodiments. In at least some embodiments, the baseline traffic within different training iterations may exhibit a fairly repeatable temporal pattern consisting of some busy periods (with high rates of training-related traffic) in each iteration, followed by some less-busy periods (with low rates of training-related traffic). In order to avoid interference between checkpoint-related traffic and baseline training-related traffic, in various embodiments a partitioning plan may be generated for transferring checkpoint contents between accelerators at different TSs of a DTE. Such a plan, which may for example be generated by a hierarchical checkpointing parameters selection engine 124 at the request of a distributed training coordinator 120, or by a distributed training coordinator itself, may use less-busy periods of the baseline training-related traffic to transfer chunks of checkpoint contents. Details of various aspects of the partitioning plans, as well as related techniques that enable accelerator-to-accelerator checkpoint data transfers to be performed in parallel with accelerator-to-main-memory data transfers, are provided below.

Using replicated checkpoints of the kind described above to help recover quickly from any failures and other training disrupting events that occur while the model is being trained, trained versions of the models may eventually be generated and stored in trained model repository 105. In response to inference requests received via programmatic interfaces 177 from clients or end users of the MLS, model execution coordinators 122 may run the trained versions and provide the inference results to the sources from which the inference requests are received. In some cases the inference requests may indicate that the results should be provided to downstream inference results consumers 156 (such as programs that initiate actions based on the inferences), and the results may be directed to such consumers.

In at least some embodiments, different clients of the MLS may have respective sets of training requirements—e.g., the timeframes within which the clients wish to complete training may differ from one client or one model to another, the training recovery-time requirements may differ, the kinds of TSs the clients wish to utilize in their DTEs may differ, and so on. Such requirements may be provided by the clients using programmatic interfaces 177, and stored in client-specific requirements repository 129. At least some parameters governing different aspects of the checkpointing for a given model of a given client may be chose by selection engine 124 based on the client-specified requirements in the depicted embodiment. In at least some embodiments, the selection engine 124 may generate recommendations for one or more checkpoint related parameters (if values for the parameters are not specified by the clients), and the recommendations may be provided to the clients for approval before the training iterations of the associated models are initiated.

In at least some embodiments, for a given ML model which is to be trained at a particular DTE, a preliminary analysis may be conducted at an MLS 102 (e.g., by a distributed training coordinator 120 or a hierarchical checkpointing parameters selection engine 124) to determine whether some or all of the aspects of the hierarchical checkpointing approach are unlikely to be useful for the model. Depending on factors such as the amount of main memory available at the TSs of the DTE relative to the amount of memory likely to be required for server-level checkpoints, whether low-training-communication periods occur regularly during training intervals of the model or not, and so on, some aspects of the checkpointing methodology may be adjusted or even avoided. For example, while it may still be advantageous to create in-memory replicas of a given checkpoint at several TSs in accordance with a placement plan, the interleaving of the checkpoint chunk transfers with training-related communication may not be feasible in some cases (e.g., if baseline training traffic does not exhibit predictable low-training-communication periods).

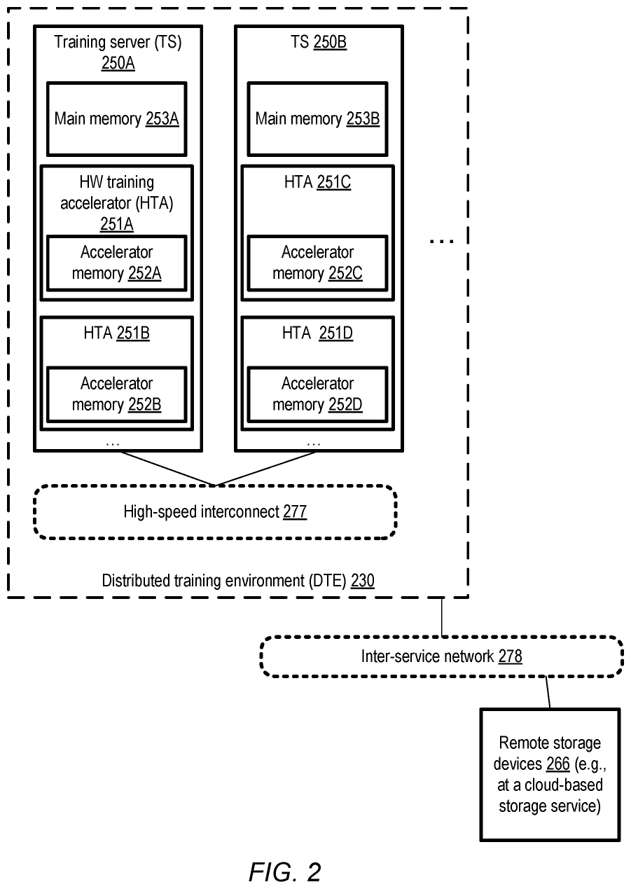

FIG. 2 illustrates example components of servers which may be used for computations performed during distributed training of machine learning models, according to at least some embodiments. A training server (TS) 250A of a DTE 230 at which an ML model is to be trained may include (in addition to other components such as CPUs, persistent storage devices, networking cards and the like) a main memory 253A and one or more hardware training accelerators (HTAs) such as HTAs 251A and 251B in the depicted embodiment. Similarly, TS 250B may include main memory 253B and one or more HTAs such as HTA 251C and HTA 251D. An HTA may comprise circuitry which is optimized to speed up training computations of machine learning models. In some embodiments, an HTA may comprise one or more GPUs. In other embodiments, custom chips designed specifically for performing training computations (such as vector, matrix or tensor operations) rapidly may be used as HTAs instead of or in addition to GPUs. A given accelerator may comprise its own accelerator memory, distinct from the main memory of the TS. For example, HTA 251A may include accelerator memory 252A, HTA 251B may include accelerator memory 252B, HTA 251C may include accelerator memory 252C, and HTA 251D may include accelerator memory 252D. In individual ones of the accelerator memories, respective subsets of model training state or status may be generated and/or stored during the distributed training of a given model.

The DTE may include a high-speed interconnect 277 in the depicted embodiment, enabling network messages to be transferred at high rates and with low latencies among the TSs. In some embodiments, the interconnect may include links or paths linking individual HTAs at a given TS directly to HTAs at other TSs, enabling fast HTA-to-HTA transfers of data.

In some conventional approaches, as mentioned above, checkpoints of the training state information may be stored only at a remote storage devices 266 (e.g., at a cloud-based storage service), such as an object storage service or a block storage service. The remote storage devices 266 may be accessed from the DTE 230 via an inter-service network 278 (e.g., a network which connects a storage service to a virtualized computing service of a cloud provider network, within which the TSs are configured) in various embodiments. The inter-service network may provide lower bandwidths and/or higher message latencies than the high-speed interconnect in at least some embodiments. Transferring checkpoints of training state information between the TSs and the remote storage devices may result in longer times for recovery after failures than if the checkpoint contents are obtained from other TSs within the DTE.

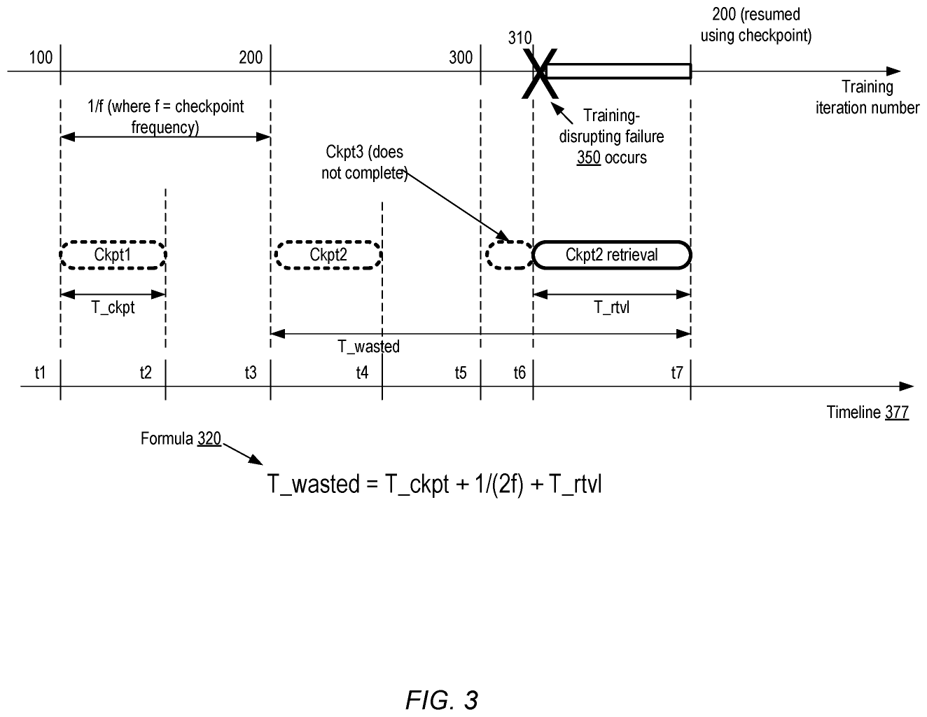

FIG. 3 illustrates an example set of factors which may contribute to wasted time when failures are encountered during training of a machine learning model for which checkpoints of training state information are stored periodically, according to at least some embodiments. In the depicted scenario, checkpoints for a particular model are generated at a DTE after every 100 training iterations of the model, and stored at remote storage devices such as those shown in FIG. 2. The checkpoint frequency f (which can be considered a parameter of the checkpointing methodology) is thus one checkpoint per 100 iterations or 1/100.

Iteration 100 is completed at time t1 along timeline 377, as indicated by the training iteration number shown towards the top of FIG. 3. A checkpoint Ckpt1 of the model as a whole (comprising state information from all the HTAs of all the training servers of the DTE) is generated starting at time t1, and transferred to the remote storage devices, with the transmission completing at time t2. The interval (t2−t1), indicating the total time taken to create, transfer and store the checkpoint at the remote storage devices, is designated as T_ckpt in FIG. 3.

In accordance with the checkpoint frequency selected, a second checkpoint Ckpt2 is created and transferred to the remote storage devices in the interval between t3 (when iteration 200 completes) and t4 (t4=t3+T_ckpt, just as t2=t1+T_ckpt). A third checkpoint Ckpt3 is started at time t5 when iteration 300 completes. However, the creation and/or transfer of Ckpt3 is interrupted at time t6, when a training-disrupting failure 350 occurs (such as a failure at one or more of the training servers being used). As a result, Ckpt3 does not reach the remote storage devices in the depicted example. At time t6, training iteration 310 was being performed.

At the time that the failure occurs, the most recent checkpoint stored at the remote storage devices is Ckpt2. So the training can only be resumed from the state represented in Ckpt2, which corresponds to iteration 200. It takes time T_rtvl to retrieve Ckpt2 from the remote storage devices and distribute it to all the training servers to enable state synchronization. At time t7, which is (t6+T_rtvl), the retrieval of the checkpoint Ckpt2 is completed, and the state at all the training servers is synchronized to the iteration 200 state. The training can then be resumed, starting at iteration 200. Note that to simplify the presentation, time which may be needed to provision and configure any hardware which may have to be replaced as a result of the training-disrupting failure, is not shown explicitly in FIG. 3

In FIG. 3, the label T_wasted (which is t7−t3) indicates the total amount of time which is lost or wasted because of the failure 350. Because the training has to be re-started at iteration 200, corresponding to the most recent checkpoint successfully stored at the remote storage devices, the state of the resumed training (at t7) in effect reverts to the state when iteration 200 originally completed (at t3).

In general, the amount of time wasted in scenarios similar to that of FIG. 3 may depend upon when (relative to the most recent completion of a checkpoint transfer) the training disrupting failure event occurs. If the event occurs very shortly after the most recent checkpoint is stored, the time wasted may be less than if the event occurs later. For example, if the failure had occurred at (t4+delta) (where delta is small), very shortly after Ckpt2 reached the remote storage, the wasted time may be approximated as (T_ckpt+T_rtvl). In contrast, if the failure occurred at (t4−delta), just before Ckpt2 is stored at the remote storage, the wasted time may be as high as approximately (T_ckpt+ (1/f)+T_rtvl). Assuming that the disrupting events occur at random times, on average, the wasted time can be expressed by formula 320: T_wasted=T_ckpt+1/(2f)+T_rtvl. Note that the following constraint may also apply on checkpoint frequency: (1/f)≥max (T_ckpt, T_iter), where T_iter is the time taken per iteration. Since model state is updated at the end of an iteration, there may be no need to create multiple checkpoints per iteration, hence the T_iter term in the constraint. Furthermore, a checkpoint need not be started until the previous one is completed, hence the T_ckpt term in the constraint.

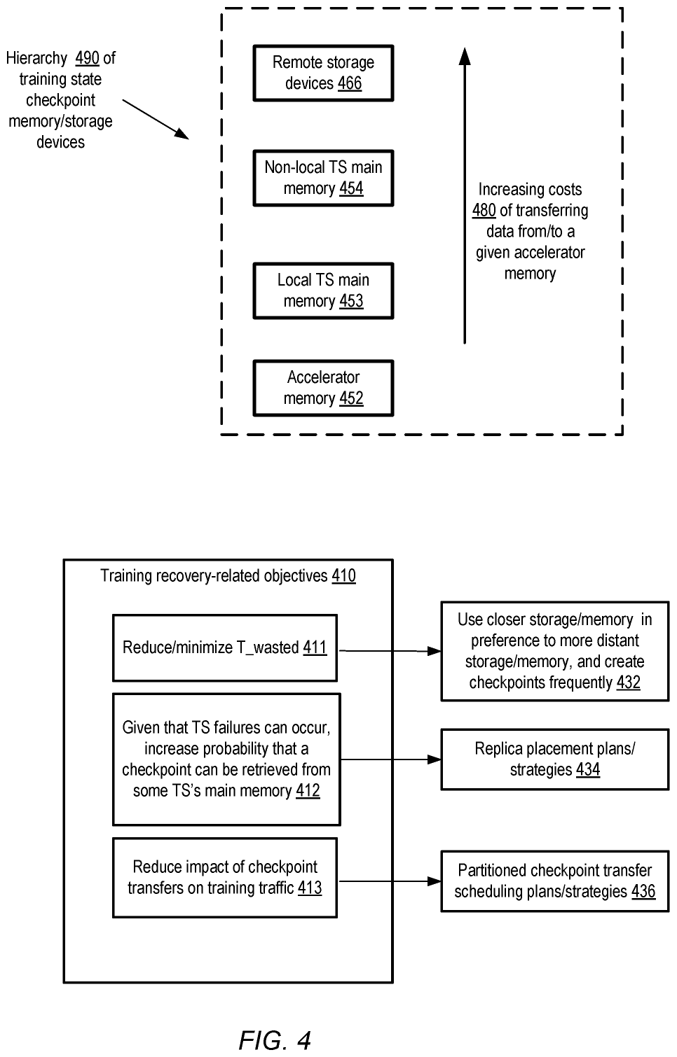

One of the primary objectives of a checkpoint-based recovery technique for the training of ML models is assumed to be reduction in the amount of time wasted as a result of training disrupting events. While remote storage devices are used for storing checkpoint contents in the scenario shown in FIG. 3, the factors which are summed up to compute T_wasted may be more generally applicable, regardless of the kind of storage or memory used for the checkpoints, and regardless of the granularity at which checkpoints are created. Thus, in order to try to reduce the wasted time. T_ckpt can be lowered, f can be increased, and/or T_rtvl can be reduced. By using a storage hierarchy of the kind discussed in FIG. 4, instead of relying on remote storage devices alone, each of these factors can be addressed in various embodiments.

FIG. 4 illustrates an example hierarchy of devices which may be used for storing model training state checkpoint contents, according to at least some embodiments. Hierarchy 490 comprises four layers: accelerator memory 452 (where respective portions of the model's training state are computed and initially stored), local TS main memory 453 (the main memory at the same training server at which the HTA is incorporated), non-local TS main memory 454 (main memory of some other training server of the DTE), and remote storage devices 466. In various embodiments, the costs 480 (e.g., in terms of the time taken) of transferring data from/to accelerator memory 452 increase from local TS main memory to non-local TS main memory, and increase further if remote storage devices are used. From a checkpoint retrieval speed perspective, local TS main memory is thus “closer” to the HTAs than non-local TS main memory, and non-local TS main memory is closer than the remote storage devices.

A set of training recovery-related objectives 410 is also shown in FIG. 4. One of the objectives is to reduce or minimize the wasted time T_wasted, as indicated in element 411. In order to achieve this objective, techniques which utilize closer storage or memory within hierarchy 490 (e.g., the main memories of TSs) for checkpoints in preference to more distant storage or memory as often as possible may be employed, as indicated in element 432. Using the closer memory may in general tend to reduce the T_ckpt and T_rtvl factors of the T_wasted formula 320. Furthermore, checkpoints may in general be created and saved relatively frequently (e.g., once every iteration or once every few iterations), thereby reducing the (1/(2f)) factor of the T_wasted formula of FIG. 3. Of course, if a TS in whose main memory a checkpoint is stored fails, the checkpoint can no longer be accessed from that TS.

A second objective, given the approach of preferentially using TS main memories and that TS failures can occur at any time, is to increase the probability that a checkpoint can be found and retrieved from some TS's main memory, as indicated in element 412. In order to achieve this second objective, checkpoint replica placement plans/strategies 434 can be generated and implemented in various embodiments. Using such plans, copies of checkpoints can be stored at different TSs, so multiple TS failures would have to occur near-concurrently to prevent rapid retrieval of checkpoints from TS main memory.

In order to transfer replicas of checkpoints to non-local TSs, the network paths or interconnect between TSs (such as high-speed interconnect 277 of FIG. 2) may be used in various embodiments. Of course, such interconnects are also used for other kinds of network traffic not related directly to checkpoints, such as a baseline level of traffic required by the training algorithm being used. If the baseline training-related traffic were to be delayed to a significant extent by the checkpoint-related traffic, this may slow down training. Accordingly, a third objective may be to reduce the impact of checkpoint transfers on training-related traffic, as shown in element 413. In order to achieve this third objective, partitioned checkpoint transfer scheduling plans or strategies 436 may be developed in various embodiments, as described below in further detail.

The terms “storage” and “memory” may be used synonymously herein, to refer to any of the layers or tiers of hierarchy 490 or similar other hierarchies. The layers of the hierarchy may be ordered by any desired performance metrics such as random or continuous read bandwidth, random or continuous write bandwidth, etc. Any of a variety of technologies may be used to implement any given layer in different embodiments, such as persistent random access memory, intermediate volatile/non-volatile devices, solid state drives (SSDs), magnetic disks and the like. At a distributed training environment, some layers or portions of layers may be referred to as “training memory”, while others may be referred to as “non-training memory”. A training memory (such as a portion of an accelerator memory) may be used by the machine learning algorithm to store model weights and/or other state information initially (e.g., as soon as the weights are computed), while a non-training memory may be used to store checkpoints (which comprise snapshots of the state information as of selected points in time). The term “main memory”, as used herein with respect to at least some embodiments, refers to any type of non-training memory that is chosen for storing checkpoints. Several layers of non-training memory may be used for checkpoints in some embodiments. After a failure event which disrupts training, a checkpoint which is needed for recovery may be retrieved from the fastest available non-training memory at which a replica of that checkpoint was stored in such embodiments.

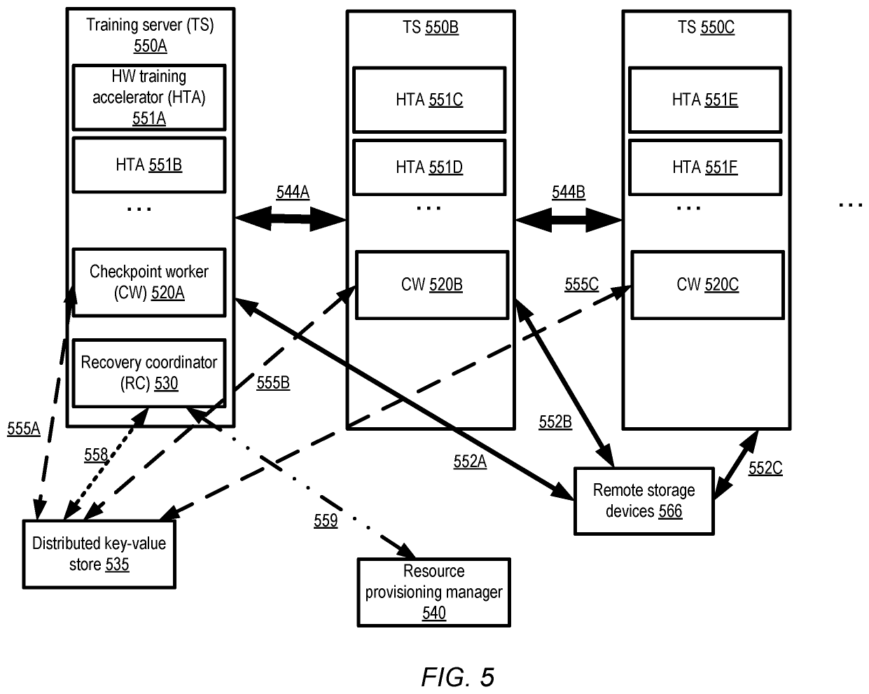

FIG. 5 illustrates an example architecture for enabling efficient checkpoint-based recovery from failures in a distributed training environment, according to at least some embodiments. Three TSs of a distributed training environment are shown by way of example: TS 550A, TS 550B and TS 550C. Each of the TSs includes some number of hardware training accelerators, such as HTA 551A and HTA 551B at TS 550A, HTA 551C and HTA 551D at TS 550B, and HTA 551E and HTA 551F at TS 550C. Computations of the training iterations of a model may be performed at the HTAs. A respective checkpoint worker (CW), for example comprising one or more processes or threads of execution, may be run at each of the TSs in the depicted embodiment. CW 520A runs at TS 550A, CW 520B runs at TS 550B, and CW 520C runs at TS 550C. The CW at a given TS may select or control checkpoint destinations and schedule checkpoint-related communications. For example, transfers of one or more replicas of a TS-level checkpoint created at TS 550A to other TSs (such as TS 550B) for eventual storage within non-local TS main memory may be orchestrated by CW 520A. Similarly, transfers of one or more replicas of a TS-level checkpoint created at TS 550B to other TSs (such as TS 550C) for eventual storage within non-local TS main memory may be orchestrated by CW 520B, and so on. Arrows 544A and 544B represent such inter-TS checkpoint transfers. In addition, the CW at a given TS may also periodically schedule the transfer of checkpoints from that TS to remote storage devices 566, as indicated by arrows 552A, 552B and 552C. The checkpoint transfers between TSs may implement placement plans and partitioning schemes as described below.

Each CW may also be responsible for periodically transferring health status information of the CW's TS to a distributed key-value store 535 in the depicted embodiment. Such health status communications are indicated by arrows 555A, 555B and 555C in FIG. 5. In some implementations, a health status update message may simply indicate that the TS from which it was transmitted to the distributed key-value store is operational and reachable via a network as of the time that the message was sent. In other implementations, more detailed metrics such as resource utilization levels may be included in a health status update message. A record added to the key-value store as a result of a health status update may include a key identifying the corresponding TS, and a value portion indicating the health status in various embodiments.

In the embodiment depicted in FIG. 5, a recovery coordinator (RC) 530 may also run at one of the TSs of the DTE. The RC may also comprise one or more processes or threads in some implementations. The RC may periodically access the distributed key-value store to check the health status of the TSs, as indicated by arrow 558. If and when the RC discovers that one of the TSs is unhealthy or unreachable, the RC may initiate a corrective action. For example, if a TS fails (e.g., the TS stops executing programs such as model training computation programs, and cannot be restarted to resume those programs), a replacement TS may be required in some embodiments. In such a scenario, the RC may request a replacement TS from a resource provisioning manager 540, as indicated by arrow 559. Furthermore, in at least some embodiments, after the replacement TS is provisioned, the RC may orchestrate the retrieval of one or more checkpoints from one or more sources (such as other TSs) to the replacement TS. After the needed checkpoints are retrieved and the states of all the HTAs at all the TSs are synchronized, the training iterations of the model may be resumed. For other types of training disrupting events, such as unexpected exits from software programs executing the training computations, other types of recovery actions (such as simply restarting the programs without provisioning any new hardware) may be initiated. Note that while a single RC is shown in FIG. 5 by way of example, in some embodiments respective RCs may be run at more than one TS of a DTE.

The CWs may also periodically check the health status of a TS at which an RC runs, e.g., by querying the key-value store in some embodiments. If and when a failure is detected at such a TS, a replacement RC may be started up at a healthy TS selected using a distributed leader election protocol in some embodiments, and a replacement TS (without an RC) may also be provisioned. In some embodiments, a distributed training coordinator of the kind shown in FIG. 1 may comprise the CWs and the RC shown in FIG. 5; as such, the CWs and the RC may be considered subcomponents of a distributed training coordinator in such embodiments.

As indicated earlier, one of the techniques utilized to enable fast recovery when ML model distributed training is disrupted may involve the placement or propagation of respective replicas of checkpoint contents at main memories of multiple TSs of a DTE. In general, increasing the number of replicas can help reduce the probability that no main memory-resident checkpoints are available when needed. However, increasing the number of replicas can also result in increasing the total amount of main memory consumed, and also in increasing network bandwidth requirements for inter-TS traffic. As such, the number of replicas may be kept relatively small (e.g., no greater than four) in various embodiments. In addition to the number of replicas, the manner in which the TSs at which the replicas are stored are selected can also influence the probability of being able to recover using main memory-based replicas.

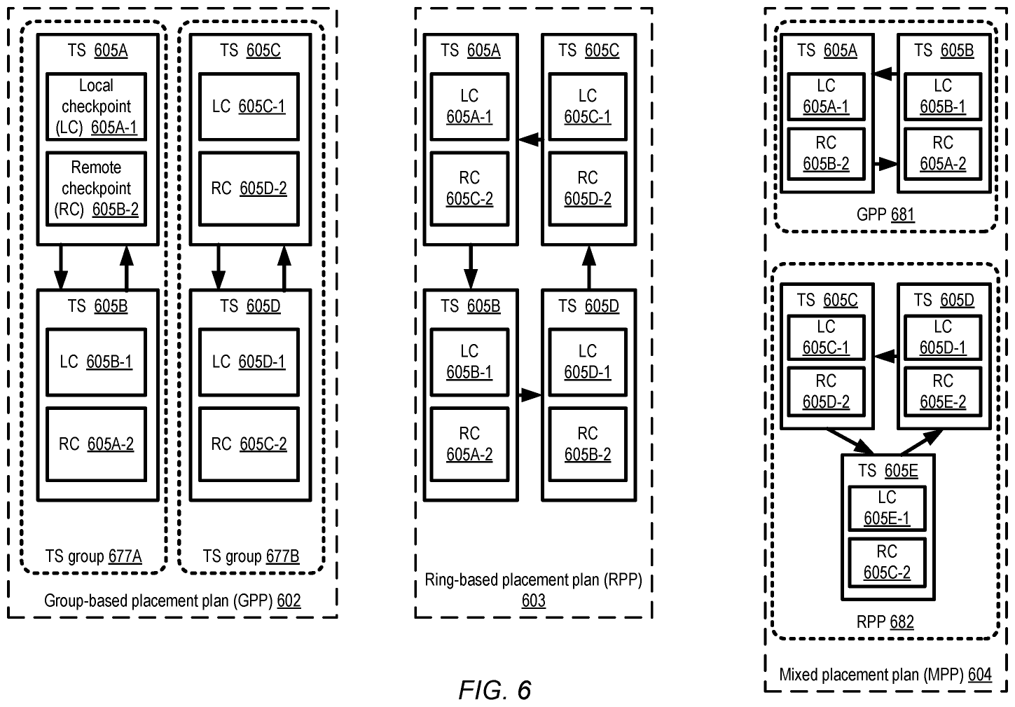

The logic used to decide which particular TSs should be used to store the replicas may be referred to as a placement plan or a placement strategy in various embodiments. FIG. 6 illustrates example types of placement plans which may be employed for storing replicas of training state checkpoints at distributed training environments, according to at least some embodiments. The problem of selecting destination TSs for checkpoint replicas may be summarized as follows: Given N TSs, and a requirement that m replicas of each checkpoint of a given TS are to be saved, what is the optimum way to place the m replicas among the N TSs, so as to maximize the probability that TS main memory can be used as the source from which a checkpoint is retrieved for failure recovery?

This problem can be addressed in several ways, each corresponding to a respective type of placement plan. In a group-based placement plan (GPP) 602, the total number of TSs of a DTE are first divided into groups based on the total number of TSs and the number of replicas required. For example, if the DTE comprises four TSs (N=4 in the above problem formulation), and two replicas (m=2) are required of each checkpoint, two groups can be created. TS group 677A comprises TS 605A and TS 605B, while TS group 677B includes TS 605C and TS 605D. Then, each TS stores a copy of its own checkpoint (a checkpoint comprising training state information from the collection of HTAs of the TS) in its local main memory, and transfers (m−1) replicas to other TSs within the group. For example, TS 605A stores local checkpoint LC 605A-1 (comprising state information from TS 605A's HTAs) in its main memory. A replica of LC 605A-1, called remote checkpoint (RC) 605A-2, is transmitted to TS 605B and stored in main memory of TS 605B. Similarly, TS 605B stores LC 605B-1 comprising state information from TS 605B's HTAs in TS 605B's main memory, and causes a replica RC 605B-2 to TS 605A. In TS group 677B, LC 605C-1 and RC 605D-2 may similarly be stored in the main memory of TS 605C, while LC 605D-1 and RC 605C-2 may be stored in the main memory of TS 605D.

An alternative type of placement plan, referred to as a ring-based placement plan (RPP), the TSs may not be divided into groups, with replication restricted within groups as in GPPs. Instead, the TSs may be organized as a ring, and replicas of local checkpoints may be sent to TSs that are located in a selected direction (e.g., clockwise or anti-clockwise) around the ring. For example in RPP 603, the ring sequence is TS 605A-TS 605B-TS 605D-TS 605C, and non-local checkpoints are propagated in the anticlockwise direction. TS 605A stores a local copy of a checkpoint LC 605A-1 in its own main memory, and sends a replica RC 605A-2 to TS 605B. Similarly, TS 605B stores a local copy of a checkpoint LC 605B-1 in its own main memory, and sends a replica RC 605B-2 to TS 605D. TS 605D stores local checkpoint LC 605D-1 in its own main memory, and sends a replica RC 605D-2 to TS 605C. TS 605C stores local checkpoint LC 605C-1 in its own main memory, and sends a replica RC 605C-2 to TS 605A.

In general, GPPs tend to provide higher probabilities of being able to recover using main memory based checkpoints than RPPs given the same number of TS failures. For example, in the scenario depicted in FIG. 6, assume that two TSs fail concurrently. The set of possible two-TS failure combinations has 6 members: (605A, 605B), (605A, 605C), (605A, 605D), (605B, 605C), (605B, 605D), and (605C, 605D). If the GPP 602 is being used, the only cases in which all replicas of a given checkpoint become unavailable is if both TSs of a given group fail: (605A, 605B) or (605C, 605D). In all other cases, at least one replica of each checkpoint remains available. In contrast, if RPP 603 is being used, and any two consecutive (in ring sequence) TSs fail, at least one checkpoint can no longer be retrieved from a TS main memory. There are four such cases: (605A, 605B), (605B, 605D), (605C, 605D) and (605A, 605C), so the probability of not being able to obtain a needed checkpoint from main memory is higher than if the GPP 602 were employed.

If the total number of TSs is not divisible by the number of replicas needed, a hybrid approach may be implemented in some embodiments, combining aspects of GPP and RPP. This approach may be referred to as a mixed placement plan (MPP). For example, MPP 604 may be employed if the DTE includes five TSs (N=5) and two replicas of each checkpoint are needed (m=2). In this case, the DTE may still be divided into groups, but the final group may include a different number of TSs than the others. For example, a GPP 681 may be employed for a group comprising TS 605A and TS 605B, while the ring-based approach may be used for a group comprising TS 605C, TS 605D and TS 605E. In the GPP 681, each TS may store a respective local checkpoint (LC 605A-1 or LC 605B-1) and a remote checkpoint (RC 605B-2 or RC 605A-2). In the RPP 682, LCs such as LC 605C-1, LC 605E-1 and OC 605D-1 may also be stored, while the remote checkpoints RC 605C-2, RC 605E-2 and RC 605D-2 may be propagated in the anticlockwise direction around the ring. In some embodiments, a given replica of an entire TS-level training checkpoint may not necessarily be stored at a single other TS; instead, for example if the TS-level training checkpoint comprises training state information from eight HTAs, training state information from four of the HTAs may be copied to main memory of one other TS in accordance with the placement plan, while training state information from the other four HTAs may be copied to main memory of another TS.

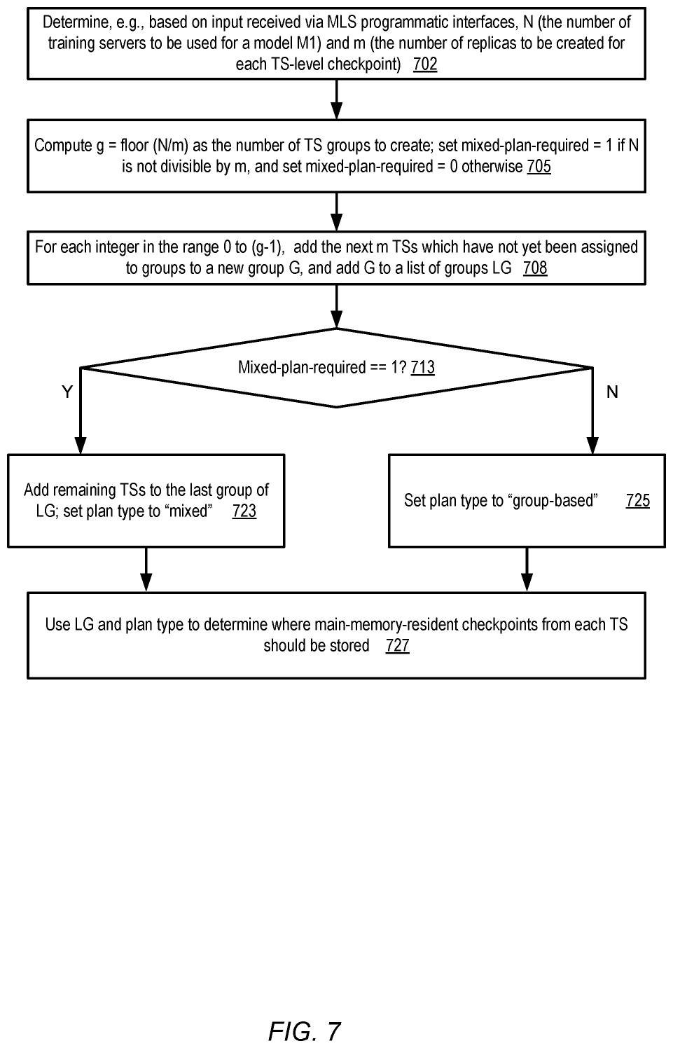

FIG. 7 is a flow diagram illustrating aspects of example operations that may be performed to create and implement a placement plan for replicas of training state checkpoints, according to at least some embodiments. A group-based placement plan of the kind described above may be used if possible; otherwise, a mixed placement plan may be used. As shown on element 702, a determination may be made, e.g., by a training coordinator of the MLS based on input received via one or more programmatic interfaces, that N training servers of a DTE are to be used to train a machine learning model M1, and that m replicas of each TS-level checkpoint are to be created and stored in main memories of the TSs of the DTE. In some embodiments, an MLS client on whose behalf M1 is to be trained may indicate both N and m explicitly. In other embodiments, the client may indicate N, and the MLS may select m based on recovery requirements indicated by the client (or based on default recovery settings of the MLS). In at least one embodiment, a client may simply provide a descriptor of the model M1 programmatically, and the MLS may choose both N and m.

The number of groups into which the TSs are to be distributed may be computed as g=floor (N/m) in the depicted embodiment (element 705). If N is not divisible by m, a Boolean parameter mixed-plan-required may be set to 1, otherwise mixed-plan-required may be set to 0.

TSs may be assigned to groups as follows in the depicted embodiment. For each integer in the range 0 to (g−1), the next m TSs which have not yet been assigned may be placed in a new group G, and G may be added to a list of groups LG (element 708).

If mixed-plan-required was set to 1, as determined in operations corresponding to element 713, the remaining TSs may be added to the final group (the group which was added most recently to LG) in the depicted embodiment, and the placement plan type may be set to mixed (element 723). In contrast, if mixed-plan-required was set to 0, the placement plan type may be set to group-based (element 725). The list of groups LG, and the plan type, may then be utilized to determine where main-memory-resident checkpoints from each TS should be stored (element 727) in the depicted embodiment. In at least some embodiments, using LG and the plan type information, a list of one or more other TSs to which checkpoints are to be transmitted from each TS may be generated and provided to the checkpoint worker of that TS. In other embodiments, LG and the plan type may be provided to the checkpoint worker, and the checkpoint worker may itself use the LG and plan type to identify the specific TSs to which checkpoints are to be transmitted.

Storing multiple replicas of checkpoints at the main memories of other TSs using the approach illustrated in FIG. 7 can substantially increase the probability that a needed checkpoint can be retrieved from one of the other TSs after a failure. For example, it can be proved that in a scenario in which N (the number of TSs) is 16 and m (the total number of replicas per checkpoint) is 2, and 2 TSs fail concurrently, the probability of recovering a checkpoint from main memory of some TS is approximately 93%. As such, just two checkpoint replicas would suffice in such configurations 93% of the time. In general, if N is divisible by m, the number of concurrent TS failures is k, and k is less than m, the probability of being able to recover using a placement plan of the kind discussed in the context of FIG. 7 is 100%. Even if k exceeds m, the probability of successful retrieval of a checkpoint from a TS's main memory remains high when the above techniques are used.

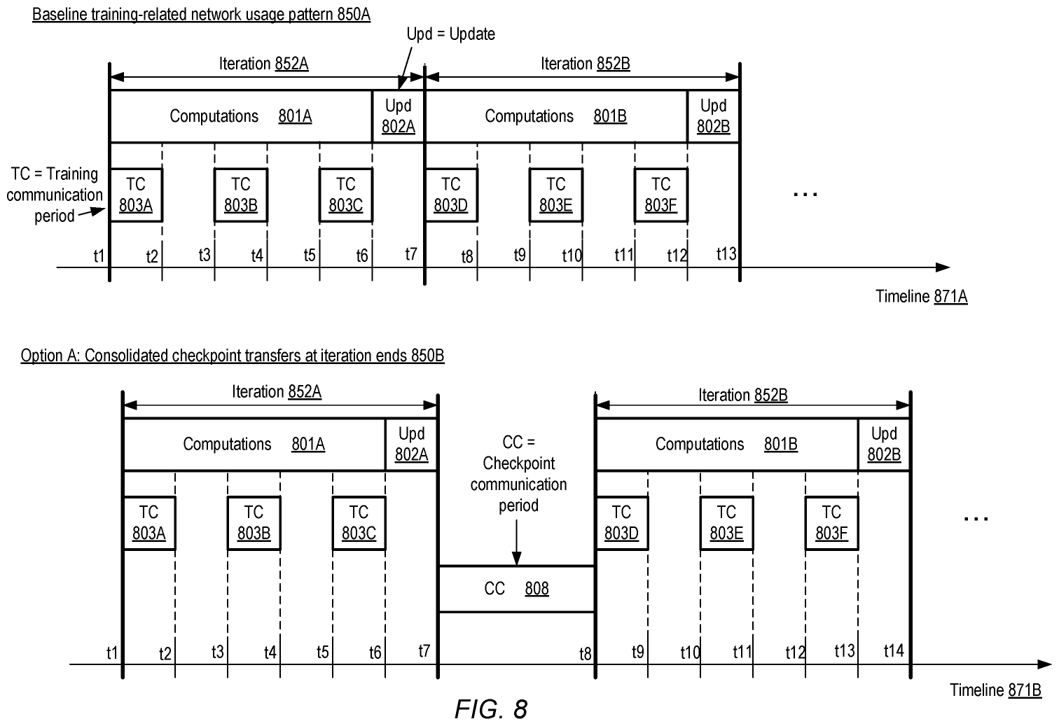

As indicated earlier, in various embodiments, a baseline amount of network traffic between HTAs at different TSs may be required during each training iteration of a model, regardless of whether checkpoints are being transmitted among TSs or not. FIG. 8 illustrates an example methodology in which consolidated transfers of training state checkpoint data may be performed at the ends of training iterations, according to at least some embodiments. An example of a sequence of phases of a baseline training-related network usage pattern 850A, from the perspective of a given HTA, is shown along timeline 871A. Two training iterations are illustrated: iteration 852A followed by iteration 852B. A given iteration can include a computations phase, followed by an update phase in which the model parameters are updated based on the local computation results and/or based on updates received from other HTAs. As indicated earlier, for at least some neural network based models, the computations may include a forward pass through the layers of the neural network, followed by a reserve pass. In iteration 852A, computation phase 801A is followed by an update phase 802A. Iteration 852B comprises computation phase 801B followed by update phase 802B. The overall duration of iteration 802A is (t7−t1), and the overall duration of iteration 802 is (t13−t7).

Measurements of the traffic flowing among various pairs of HTAs during the training iterations tend to reveal that for at least some types of training algorithms, the usage of the interconnect for training-related traffic is not uniform during any given iteration, and that the pattern of the usage tends to repeat for each iteration. For example, in some cases, each HTA may need to communicate with other HTAs at the beginning of both the forward and backward passes, but the level of traffic in between is quite low (e.g., approaching or equal to zero). Such training-related communications can block further computation, for example if/when the model states of one layer of a neural network are not ready but the computation of a previous layer are complete. Along timeline 871A, the training-related communication periods are labeled “TCs”. In iteration 852A, TC 803A occurs from t1 to t2, TC 803B occurs from t3 to t4, and TC 803C occurs from t5 to t6. In iteration 852B, a similar pattern in repeated: TC 803D occurs from t7 to t8, TC 803E occurs from t9 to t10, and TC 803F occurs from t11 to t12. This type of pattern suggests the possibility of using the gaps between TCs for transferring checkpoints between the HTAs.

Note that the relative durations of various phases (such as training communication periods relative to computations of iterations) shown in FIG. 8 and subsequent figures illustrate the concepts and factors taken into account to schedule transfers of checkpoint data from one HTA to another, and are not intended to imply that such relative durations are a requirement for the scheduling of the checkpoint data. Similarly, for some models and some distributed training algorithms, the number of training communication periods may not match the number shown in the figures.

Assume for simplicity that HTA-level checkpoints (comprising state information updated at a given HTA) are created once an iteration at each HTA, and therefore have to be transmitted to at least one other HTA once an iteration. One straightforward approach towards the transfer of such checkpoints between HTAs may comprise transferring the entire HTA-level checkpoint state at the end of each iteration. This approach is labeled option A: consolidated checkpoint transfers at iteration ends 850B in FIG. 8. After iteration 852A ends at a given HTA at time t7 along timeline 871B, the checkpoint would be created and transmitted during a checkpoint communication period CC 808 to a destination HTA. Assume that the transfer of the checkpoint requires a time period (t8−t7). If the same network links/paths are used for baseline training-related communications and for checkpoint transfers, this means that iteration 852B, which requires TC 803D, may have to be deferred until t8. As such, the consolidated checkpoint transfers technique may result in unacceptable delays to the overall training process in at least some embodiments. Note that in various embodiments, the rate at which HTA-level checkpoints are created and transferred may not necessarily be once per iteration; instead, the rate may be set for example to once per every few iterations, so even if consolidated checkpoints were used, the overhead for each consolidated checkpoint may be spread or amortized over several iterations.

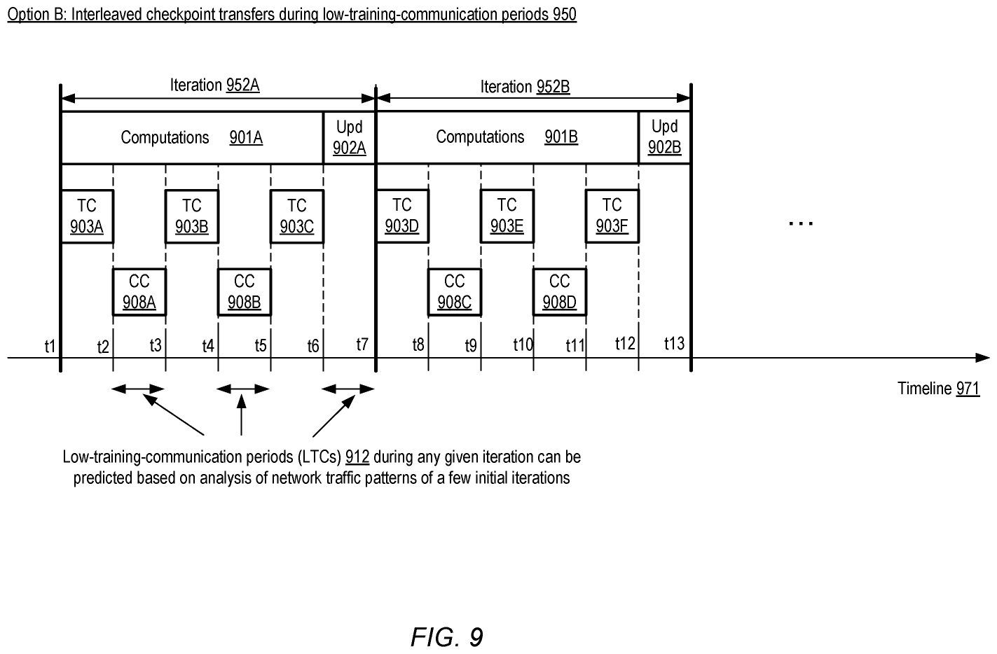

As suggested above, the gaps between the training communication periods (TCs) may provide an opportunity for reducing the interference (with regards to network bandwidth) between training-related traffic and checkpoint-related traffic. FIG. 9 illustrates an example methodology in which transfers of training state checkpoint data may be scheduled during time periods in which the rate of training traffic is low, according to at least some embodiments. In the approach labeled option B: interleaved checkpoint transfers during low-training-communication periods 950, the timings of low-training communication periods (LTCs) 912 expected during training iterations such as iteration 952A and 952B shown along timeline 971 may be predicted at the MLS. For example, measurements and analysis of the inter-HTA network traffic during a few initial iterations of a model's distributed training may be conducted. Then, based on results of the analysis, it may become possible to predict (for example) that TC 903A during iteration 952A is likely to last from approximately t1 to approximately t2, that TC 903B is similarly likely to last approximately from t3 to t4, and that TC 903C is likely to last approximately from t5 to t6. The pattern may be repeated in iteration 852B, with the approximate timings of TC 903D. TC 903E and TC 903F being predicted based on the measurements of the initial set of iterations. Iterations such as 952A may include respective computation phases (computations 901A or computations 901B) followed by update phases (updates 902A or updates 902B).

The approximate start and end times of each LTC 912 may thereby also be predicted, since each LTC comprises a gap between a pair of successive TCs. In option B, the transfer of portions or partitions of the checkpoints may be scheduled during the LTCs, thereby interleaving periods of checkpoint-related traffic with periods of training-related traffic, and avoiding the kinds of training delays that may occur of checkpoints were only transferred at the ends of iterations. Techniques for identifying the sizes of the partitions are described in further detail below.

In FIG. 9, checkpoint communication period CC 908A (used for a portion of a given checkpoint Ckpt1, comprising state information of an iteration earlier than iteration 952A) may be scheduled between TC 903A and TC 903B, CC 908B (used for another portion of Ckpt1) may be scheduled between TC 903B and TC 903C, CC 908C (for a portion of a subsequent checkpoint Ckpt2) may be scheduled between TC 903D and TC 903E, and CC 908D (used for another portion of Ckpt2) may be scheduled between TC 903E and TC 903F. Note that, depending on the sizes of the checkpoints and the speed of the interconnect, not all the LTCs need necessarily be used for checkpoint transfers in some cases—for example, in the scenario shown in FIG. 9, the LTC between t6 and t7 may not be used for checkpoint transfers. Note also that the predictions of the LTCs starting and stopping times need not be completely accurate to enable substantial reduction in interference between training-related traffic and checkpoint-related traffic in various embodiments; even if there is some overlap between an actual TC and a CC scheduled immediately prior to that TC, the amount of time for which the interference affects the training may be quite low.

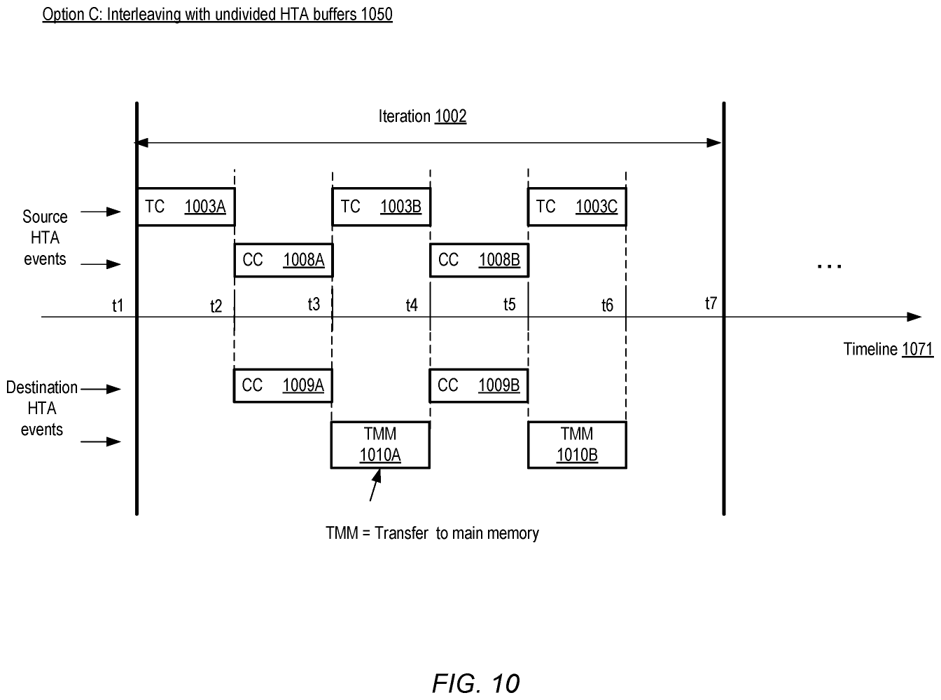

In the scenarios depicted in FIG. 8 and FIG. 9, the timings of checkpoint related operations were shown from the perspective of a single HTA involved in the communications (e.g., a source HTA from which the checkpoint contents are transmitted to a destination HTA). In various embodiments, to accomplish the objectives of the main memory-based checkpointing methodology, the checkpoint contents received at the destination HTA at a given TS may have to be copied from the HTA memory of the destination HTA to main memory of the TS. FIG. 10 illustrates an example methodology in which transfers of training state checkpoint data from a destination training accelerator's memory to main memory of the corresponding training server are performed after all the checkpoint state data being transferred to the destination training accelerator during a low-training-communication time period has been received, according to at least some embodiments.

FIG. 10 shows events, during a particular training iteration 1002 at a source HTA, at both the source HTA and a destination HTA of a checkpoint transfer. Events at the source HTA are shown above the timeline 1071, while events at the destination HTA are shown below the timeline. The approach illustrated in FIG. 10 may be referred to as option C: interleaving with undivided HTA buffers 1050. To accomplish the transfer of checkpoints between HTAs, a portion of the HTA memory may be reserved for the checkpoints (e.g., checkpoints being sent to other HTAs, and also checkpoints being received from other HTAs) in various embodiments. The portion of the HTA memory which is reserved at the source HTA for storing the outbound checkpoint contents may be referred to as a send buffer in some embodiments, and the portion of HTA memory which is reserved at the destination HTA to receive the checkpoint contents may be referred to as a receive buffer. To simplify the presentation, it is assumed that the send buffer and the receive buffer have the same size, and that the checkpoint contents are partitioned in such a way that during a given CC, an entire partition (also referred to as a chunk) is transmitted from the source HTA to the destination HTA.

In option C, contents of the entire send buffer (e.g., a partition of the checkpoint being sent) may be sent as a unit from the source HTA to the destination HTA. For example, in CC 1008A between TC 1003A and TC 1003B, one partition of the checkpoint may be transferred into the receive buffer of the destination HTA, while another partition may be transferred into the receive buffer of the destination HTA in CC 1008B between TC 1003B and TC 1003C. From the perspective of the destination HTA, the reception of the first partition may be represented as CC 1009A. At the destination HTA, the received partition may then to be copied from the HTA memory to the main memory of the TS. The copy from HTA memory to main memory may be accomplished during a time interval referred to as a transfer to main memory period or TMM 1010A. The transfer to main memory may use a different set of resources that the resources used to receive data from the source HTA in some embodiments; as such it may be possible, at least in principle, to transfer data to main memory at the destination HTA in parallel with (or concurrently with) receiving data from the source HTA. Note, however, that at least in some embodiments, the destination HTA may not be able to start receiving the next partition of the checkpoint in the receive buffer until the current partition is fully transferred to main memory from the receive buffer (e.g., in order to avoid overwriting and hence losing part of a checkpoint). As a result, in some cases the transfer of the next partition from the source HTA may have to be deferred until the receive buffer at the destination HTA becomes available; in effect, the durations of the TMMs such as TMM 1010A and TMM 1010B may gate the starting of the CCs (such as CC 1008B and CC 1009B). Of course, if the TMM 1010A is shorter than the TC 1003B, and TMM 1010B is shorter than TC 1003C, this may not present a problem, as the receive buffer would become available for the next partition before the source HTA can send the next partition. However, to reduce the probability of delays in checkpoint transfers, the transfers of the checkpoint partitions may be divided into smaller steps in some embodiments as discussed below.

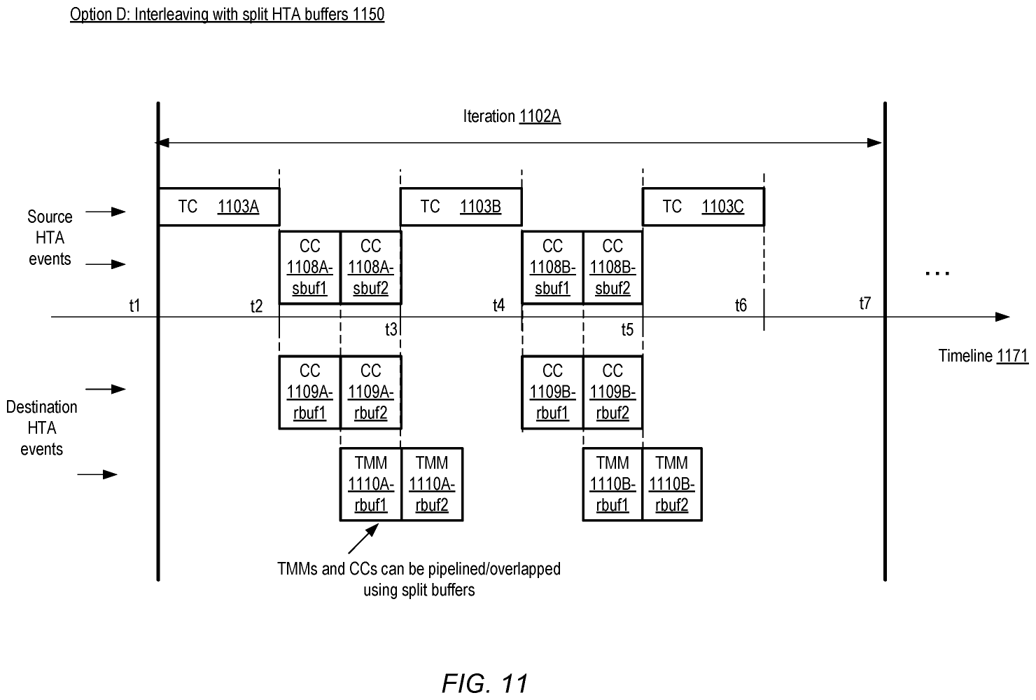

FIG. 11 illustrates an example methodology in which transfers of training state checkpoint data from a destination training accelerator's memory at a training server to main memory of that training server are performed in parallel with transfers of checkpoint data to the destination training accelerator, according to at least some embodiments. In option D: interleaving with split HTA buffers 1150, the send buffer at the source HTA may be divided into smaller units (which may be referred to as sub-buffers), and the receive buffer at the destination HTA may also be split into smaller sub-buffers. For example, the send buffer may be split into two equal sized sub-buffers sbuf1 and sbuf2, and the receive buffer may also be split into two equal sub-buffers rbuf1 and rbuf2. Instead of sending the entire checkpoint partition in one unit, half the partition may be sent from sbuf1 and stored in rbuf1 at the destination, and then the second half may be sent from sbuf2 and stored in rbuf2. Between TC 1103A and TC 1103B along timeline 1171, the first half of one partition of the checkpoint may be sent during interval CC 1108A-sbuf1, and received during CC-1109A-rbuf1. As soon as rbuf1 fills up with the first half of the partition, the transfer of that first half to the main memory (labeled TMM 1110A-rbuf1) may begin in the depicted scenario. Meanwhile, the second half of the partition may be transmitted from sbuf2 during CC 1108A-sbuf2, and stored within rbuf2 during CC 1109A-rbuf2. As indicated by the relative positioning of CC 1109A-rbuf2 and TMM 1110A-rbuf1, the receiving and storing of the second half of the partition into rbuf2 may occur at least partly in parallel with, or at least partly concurrently with, the transfer of the first half of the partition to main memory from rbuf1. Such overlaps between the HTA-to-HTA transfer of checkpoint data and the HTA-memory-to-main-memory transfer of checkpoint data may help avoid scenarios in which the sending HTA has to wait for receive buffers to become available before initiating the HTA-to-HTA transfer.

A similar approach may be taken in various LTCs in the scenario shown in FIG. 11. For example, in the LTC between TC 1103B and TC 1103C, the first half of the next partition of the checkpoint may be sent during CC 1108B-sbuf1 and received during CC 1109B-rbuf1, with the corresponding transfer to main memory being conducted in TMM 1110B-rbuf1. The second half of the partition may be transmitted during CC 1108B-sbuf2 and received during CC 1109B-rbuf2, and transferred to main memory during TMM 1110B-rbuf2. CC 1109B-rbuf2 and TMM 1110B-rbuf1 may overlap at least partly in time. The option D approach may be referred to as pipelined partitioning. In addition to avoiding delays in transfers of checkpoints, the option D scheme illustrated in FIG. 11 may have the further benefit that the probability of running out of accelerator memory (which may potentially occur if the size of a given checkpoint partition exceeds the amount of free HTA memory available) is reduced. Note that while the HTA memory reserved for checkpoints is shown as being split into halves in FIG. 11, in some embodiments the split may be into quarters, eighths, or some other fraction.

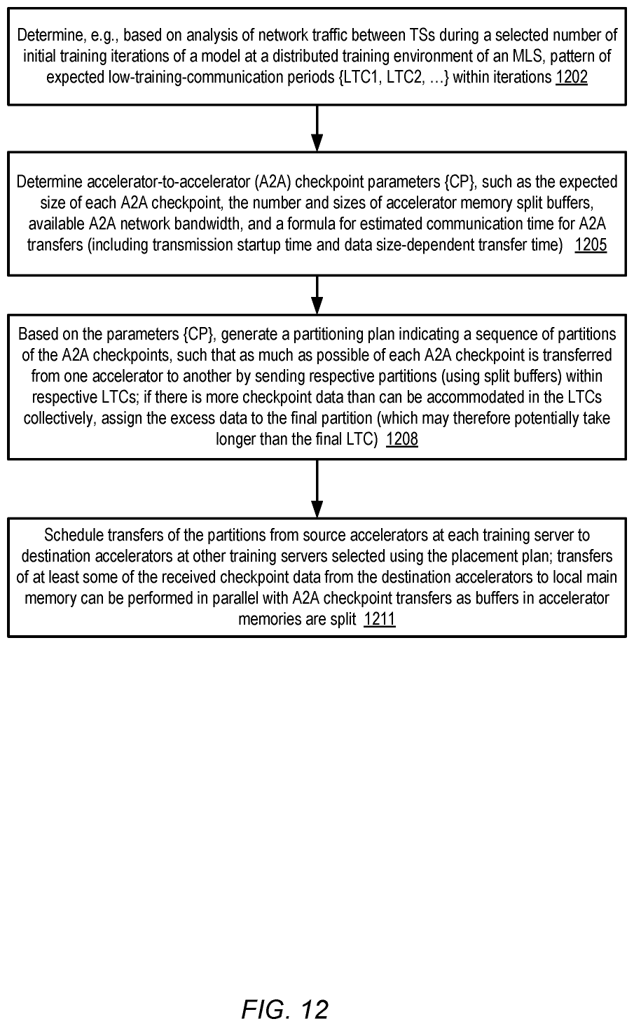

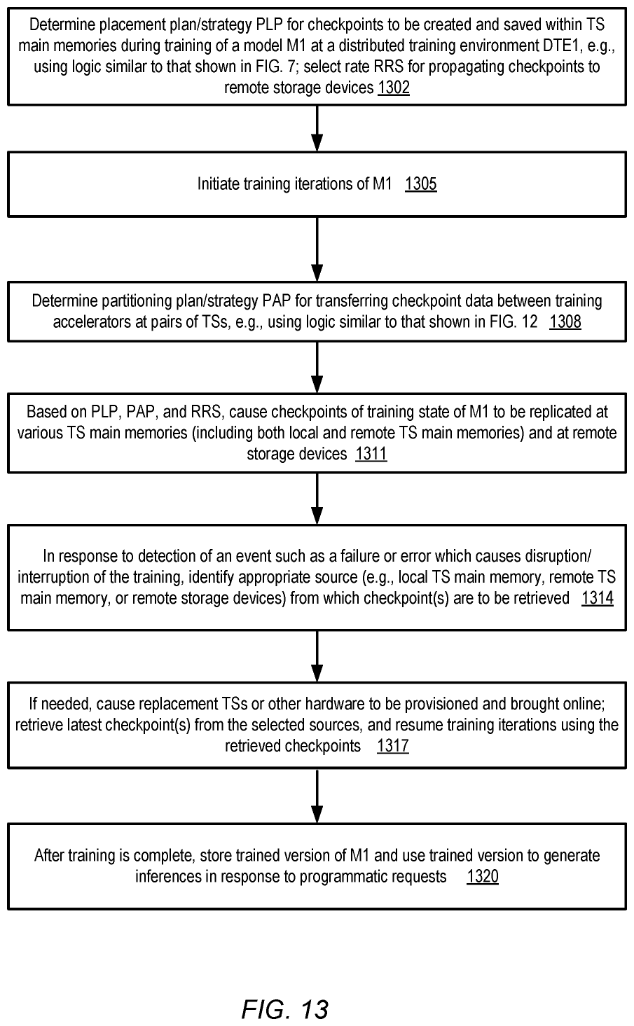

FIG. 12 is a flow diagram illustrating aspects of example operations that may be performed to partition training state checkpoint data for efficient transfers between training accelerators at respective training servers, according to at least some embodiments. As shown in element 1202, a determination may be made, e.g., at an MLS based on analysis of network traffic between HTAs at different TSs of a DTE during a selected number of initial training iterations of a model, of a pattern of expected low-training-communication periods {LTC1, LTC2, . . . } within individual iterations. For example, in one implementation, the traffic may be analyzed for between ten and twenty iterations, in which checkpoints may not be created (thereby ensuring that the traffic measured is the baseline training-related traffic, and not caused by checkpoint-related activity). The pattern of measured LTCs may then be used to make probabilistic predictions about LTCs in subsequent iterations.

After the measurements are conducted, a set of accelerator-to-accelerator (A2A) checkpoint parameters {CP} may be obtained, estimated or computed in the depicted embodiment (element 1205). These parameters may include, for example, the expected size of each HTA-level checkpoint, the total size of the HTA memory buffers available, the number and size of split sub-buffers (similar to sbuf1, sbuf2, rbuf1 and rbuf2 discussed in the content of FIG. 11), the available A2A network bandwidth, a formula for estimating communication time for A2A transfers (which may include terms representing transmission startup time, as well as data size-dependent transfer time), and so on. In addition, in at least some embodiments, a statistical metric of the variation in the LTCs across different iterations (e.g., variations in LTC start times relative to start of iterations, and/or variations in LTC durations) may also be computed at this stage.

Based at least in part on the set of parameters {CP}, a partitioning plan indicating a sequence of partitions of the A2A checkpoints may be generated in various embodiments (element 1208). The plan may attempt to ensure that as much as possible of each A2A checkpoint is transferred from one HTA to another by sending respective partitions (using split buffers) within respective LTCs. Note that in some cases, in aggregate there may be more checkpoint data than can be accommodated entirely within the predicted LTCs of a given iteration. Assuming that the checkpoints are to be transferred once per iteration, the remaining checkpoint data (the part that cannot be transferred during LTCs alone) may be included in the last partition. In such a scenario, at least some of the checkpoint contents may be transferred from one HTA to another during a time period which was not a predicted LTC.

In some embodiments, logic similar to that shown in pseudo-code section PS1 shown below may be used to generate the partitioning plan. The pseudo-code covers cases in which a total of m HTA-level checkpoint replicas are created in a given training iteration, with (m−1) of the partitions being transferred to other HTAs via a network. In the pseudo-code, a linear model of message transfer costs is assumed, in which a given message of size s requires a communication startup time (referred to as “a”) followed by a message-size-dependent time (s/B, where B is the bandwidth assumed to be available between any two HTAs) for conveying the message.

After the partitioning plan has been generated, transfers of checkpoint partitions may be scheduled according to the plan in various embodiments (element 1211), with the TSs of the destination HTAs being chosen based on a placement plan selected using logic similar to that shown in FIG. 7. As a result of using split buffers (in a manner similar to that illustrated in FIG. 11), transfers of at least a portion of the received checkpoint data from the destination HTA memories to main memory may be performed in parallel with A2A checkpoint transfers in some embodiments.

```
------Start pseudo-code PS1 for partitioning plan ---------------------
Assumption: One HTA-level checkpoint replica is to be transferred from
a source HTA to
each of one or more destination HTAs per training iteration
Inputs: {LTC}: sequence of d predicted low-training-communication
periods per iteration
  C: size of HTA-level checkpoint
  m-1: number of replicas of checkpoints that are to be saved at
  destination HTAs
  R: total size of reserved HTA memory to be used for checkpoints
  p: number of sub-buffers into which reserved HTA memory is split
  B: HTA-to-HTA network bandwidth
  u: coefficient of variance of LTCs across iterations
  a: communication startup time for transferring data to remote HTA
  f(s) = a + s/B is the time taken to transfer data of size s from
  HTA to HTA
Output: proposed checkpoint partitions
Function generate_partitions( ):
```

| | |
|---|---|
| Set LTC[d] to infinity | // there may be more checkpoint data |
| | than can be |
| | // accommodated in the LTCs alone, |
| | so set the duration of |
| | // the final LTC to infinity |

```
  Partitions = { } // initialize empty sequence of partitions
  replica_id = 0 // initialize checkpoint replicas
  remain_size = C // initialize remaining size of data for the
  first replica
  foreach LTC in {LTC} do
    remain_time = u × LTC // remaining time in LTC, set based on
```

// predicted LTC and measured
variation in LTC

```
    while remain_time > 0 do
      if (remain_time ≥ f(R/p)) then
```

size = R/p

else

size = max (0, (remain_time −
a) × B))

```
      endif
      size = min(remain_size, size)
      if (size > 0) then
```

remain_size = remain_size − size
remain_time =
remain_time − f(remain_size)
Partitions.add(size)

```
      endif
      if (remain_size == 0) then
```

```
if (replica_id < (m − 1)) then
  replica_id += 1
  remain_size = C
else
  return Partitions
endif
```

```
      endif
    endwhile
  endfor
return Partitions
------End pseudo-code PS1 for partitioning plan ---------------------
```

FIG. 13 is a flow diagram illustrating aspects of example operations that may be performed to create training state checkpoints at several levels of a storage hierarchy, and utilize checkpoints from selected levels to respond to training disruptions, according to at least some embodiments. As shown in element 1302, a placement plan or strategy PLP may be determined or generated for training state checkpoints which are to be saved in the main memories of various TSs during the distributed training of a model M1 at a distributed training environment DTE1 in the depicted embodiment. Logic similar to that shown in FIG. 7 may be employed to generate PLP in at least some embodiments, with the available TSs of DTE1 being divided into groups based at the number of TSs and the number of replicas to be stored for each checkpoint. In some embodiments, the frequency or rate at which the in-memory checkpoints are to be created and propagated, e.g., once per training iteration or once per every few training iterations, may also be selected at this stage. The rate may be selected, e.g., based on a tradeoff between the overhead of checkpoint-related traffic and the anticipated amount of time (given the selected rate) that it may take to restart training iterations after a failure of a particular type. The checkpoint-related traffic would tend to increase as the frequency or rate is increased, and the wasted time before restarting training iterations would tend to decrease as the frequency is increased. A rate or frequency RRS for propagating checkpoints from TSs to a selected set of remote storage devices may also be determined in various embodiments.

The training iterations of M1 may be initiated (element 1305) using the TSs of DTE1. In at least some embodiments, for a selected number of initial training iterations, checkpoints for in-memory replication at the TSs may not be created or propagated; instead, the baseline patterns of training-related traffic may be measured. A partitioning plan or strategy PAP may be determined for M1's checkpoints may be determined/generated, (element 1308) e.g., using logic similar to that illustrated in FIG. 12. In some embodiments, program code which implements pseudo-code similar to pseudo-code PS1 shown above may be employed to identify the partitions or chunks of the checkpoints that are to be sent to various destination HTAs from a given HTA.

Based at least in part on PLP and PAP, checkpoints of training state information of M1 may be replicated at various TS main memories in the depicted embodiment (element 1311). In some cases, one copy/replica of each TS-level checkpoint (aggregated for example from the different HTA-level checkpoints of the TS) may be stored in the local main memory of the TS, while one or more other copies/replicas may be transmitted to other TSs. In addition, at least some copies of the checkpoints (e.g., HTA-level checkpoints, TS-level checkpoints or global M1-level checkpoints generated by aggregating TS-level checkpoints) may be stored at remote storage devices in accordance with RRS.

At some point during the training, occurrence of an event which causes disruption of the training iterations (such as a failure of one or more TSs, one or more software errors, or a network problem) may be detected, e.g., by a recovery coordinator similar to RC 530 of FIG. 5. In response to the detection, one or more sources from which checkpoint contents needed to resume the training iterations can be retrieved may be identified (element 1314). For example, in some embodiments, transient errors within the persistent storage system which includes the remote storage devices used for checkpoints may cause training processes or threads running at one or more HTAs to crash. For such software-related training disruption events, the training iterations may be resumed by, for example, simply restarting the crashed processes/threads and loading checkpoint state from the local TS main memory into the HTA memory. Hardware failures, such as bit corruptions caused by radiation, failures at HTAs, TS CPUs, TS main memory and/or network links/devices of the DTE1 interconnect may require replacement of the failed components in some cases. In various embodiments, a recovery coordinator may identify the set of appropriate sources based on the nature of the disrupting event, with the objective being to retrieve the checkpoint contents as quickly as possible (so sources that are closer, from the network perspective, to the TS at which the retrieved checkpoints are to be placed may be chosen preferentially to more distant sources).

If needed, replacement TSs or other hardware components may be provisioned in response to the disrupting events and brought online (element 1317). The most recent checkpoints that are needed (e.g., checkpoints that were generated at a failed TS which has now been replaced) may be retrieved, and training iterations may be resumed using the retrieved checkpoint(s). Checkpoint creation and replication may also be resumed; if additional disruptive events interrupt the training, operations similar to those indicated in elements 1314 and 1317 may be performed again. After the entire training is eventually completed, a trained version of M1 may be stored (element 1320), e.g., at a repository of an MLS similar to MLS 102 of FIG. 1. In response to inference requests received via programmatic interfaces, the trained version of M1 may be executed and the corresponding inference results may be transmitted to one or more destinations in various embodiments.

It is noted that in various embodiments, some of the operations shown in the flow diagrams of FIG. 7, FIG. 12 and/or FIG. 13 may be implemented in a different order than that shown in the figure, or may be performed in parallel rather than sequentially. Additionally, some of the operations shown in FIG. 7, FIG. 12 and/or FIG. 13 may not be required in one or more implementations.

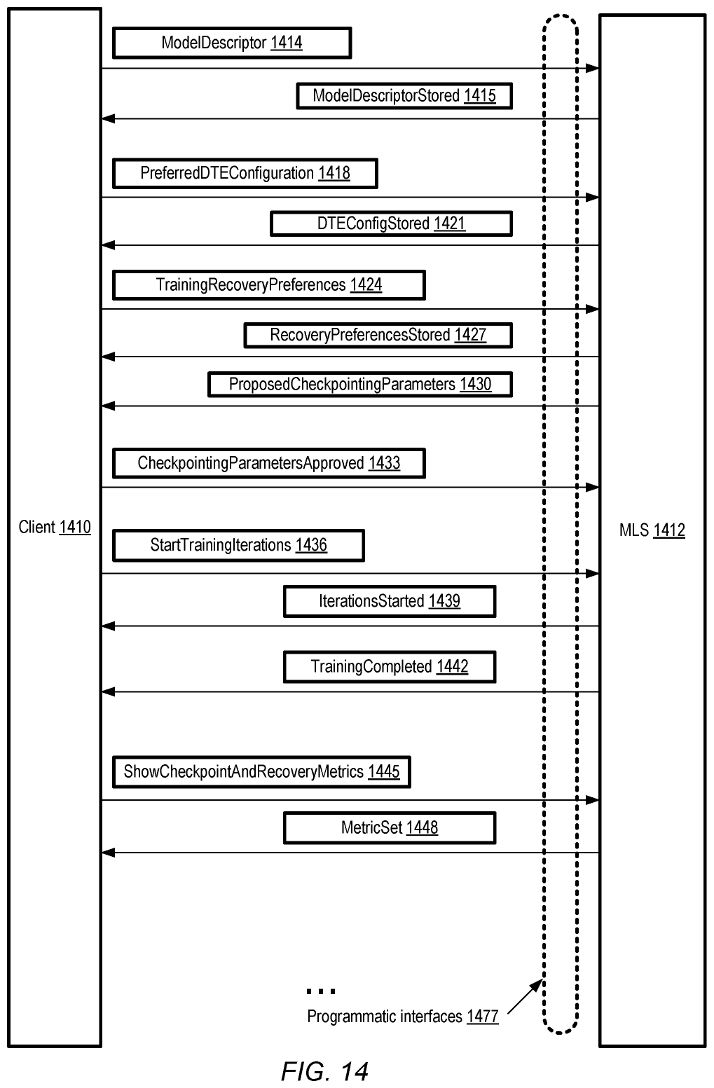

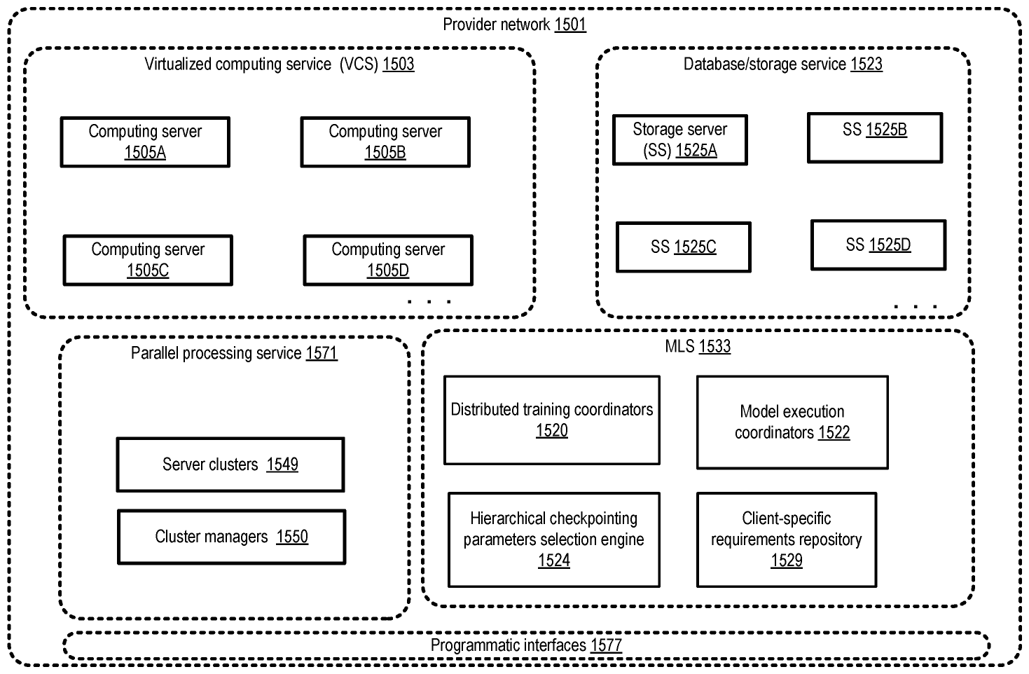

FIG. 14 illustrates example programmatic interactions associated with the creation and use of training state checkpoints, according to at least some embodiments. In the depicted embodiment, an MLS 1412, similar in features and functionality to MLS 102 of FIG. 1, may implement a set of programmatic interfaces 1477 which can be used by customers or clients 1410 (e.g., users on whose behalf distributed training of ML models is to be implemented) to submit requests and messages related to their models, and to receive corresponding responses. The programmatic interfaces 1477 may include, among others, one or more web-based consoles, command-line tools, graphical user interfaces and/or application programming interfaces (APIs) in different embodiments.

Using the programmatic interfaces, in at least some embodiments a client 1410 may submit a ModelDescriptor message 1414 indicating properties of a model which is to be trained in a distributed manner. The properties may include, for example, the ML algorithm or model type (e.g., whether the model is a transformer-based generative AI model such as a large language model), the number of parameters to be learned, the architecture of the model (e.g., the number and types of neural network layers, in scenarios in which the model comprises a neural network), and so on. The descriptor of the model may be stored at a repository of the MLS, and a ModelDescriptorStored message 1415 may be sent to the client.

In various embodiments, a client 1410 may submit a representation of a DTE configuration to be employed for the training of the model, e.g., via a PreferredDTEConfiguration message 1418. The DTE configuration information may be saved at a repository of the MLS, and a DTEConfigStored message 1421 may be sent to the client in some embodiments. The client may, for example, indicate the kinds of TSs (with various TSs including one or more HTAs of a type selected by the client) to be employed for the training. In some embodiments, for example, the client may acquire or reserve a set of compute instances of a virtualized computing service (VCS) of a cloud computing environment or provider network for training the model, with individual ones of the compute instances running at respective virtualization hosts comprising one or more CPUs and HTAs. The client may indicate the set of acquired compute instances in the PreferredDTEConfiguration message in such embodiments. In other embodiments, in response to a request for a configuration for training the model, a component of the MLS such as a distributed training coordinator, may generate a proposed or recommended DTE configuration given the properties of the model which were indicated in a model descriptor. The proposed configuration may be transmitted to the client; the client may then approve the recommendation using a PreferredDTEConfiguration message (or submit a representation of a different DTE configuration if desired).

According to one embodiment, a client 1410 may send a TrainingRecoveryPreferences message 1424 to the MLS, indicating for example a targeted recovery time (wasted time before training can be resumed) for one or more types of failures or other disruptive events which may occur. The recovery preferences may be saved at a repository (such as a client-specific requirements repository of the kind shown in FIG. 1), and a RecoveryPreferencesStored message 1427 may be sent to the client. In some embodiments, the recovery preferences may be expressed in other ways—for example, the client may indicate a total amount of time to be used to complete a targeted number of iterations of the training (regardless of the number or types of disruptive events which may occur), or to complete the training based on achieving metrics of model quality.

In at least some embodiments, the MLS may generate or choose a set of checkpoint-related parameters based on the recovery preferences (e.g., using logic similar to that shown in FIG. 7), and send a ProposedCheckpointingParameters message indicating the selected parameters 1430 to the client. The parameters may for example indicate the number of replicas of main-memory-resident checkpoints that are to be created, the frequencies of checkpoints to main memory and to remote storage, the amount of HTA memory which is to be reserved for checkpoints, and so on. In various embodiments in which such proposed checkpointing parameters are generated by the MLS and sent to the client, the client may in turn send a CheckpointingParametersApproved message 1433 indicating that the client has approved the use of the parameters.

A client may submit a StartTrainingIterations request 1436 via the programmatic interfaces in some embodiments, indicating that the training of the model is to be initiated using a DTE. After the iterations are started at the DTE, the MLS may send an IterationsStarted message 1439 to the client. Eventually, the training may be completed, and a TrainingCompletedMessage 1442 may be sent to the client to indicate this. Of course, if any events which disrupt the training occur, the MLS may utilize the techniques indicated above to obtain the needed checkpoints of training state information as quickly as possible, and restart the training as of the state captured in the checkpoints.

According to at least some embodiments, the MLS may collect various metrics regarding training disruptions and corresponding checkpoint-based recoveries. Such metrics may, for example, include the number of checkpoints created and the total network traffic resulting from propagation of the checkpoints, the fraction/size of main memory and/or HTA memory at various TSs which was used for checkpoints, the number and class of disruptive events (e.g., software failures vs. HTA failures vs. TS hardware failures vs. network failures), temporal distribution of the failures among the training iterations, the wasted time resulting from the disruptive events, the distributions of times taken to retrieve checkpoints for recovery, and so on. A client may a submit ShowCheckpointAndRecoveryMetrics message 1445 to view such metrics with respect to a given model in the depicted embodiment. The requested metrics may be provided via one or more MetricSet messages 1448. In some embodiments, programmatic interactions other than those shown in FIG. 14, related to the distributed training of ML models and corresponding checkpoints, may be supported by an MLS.

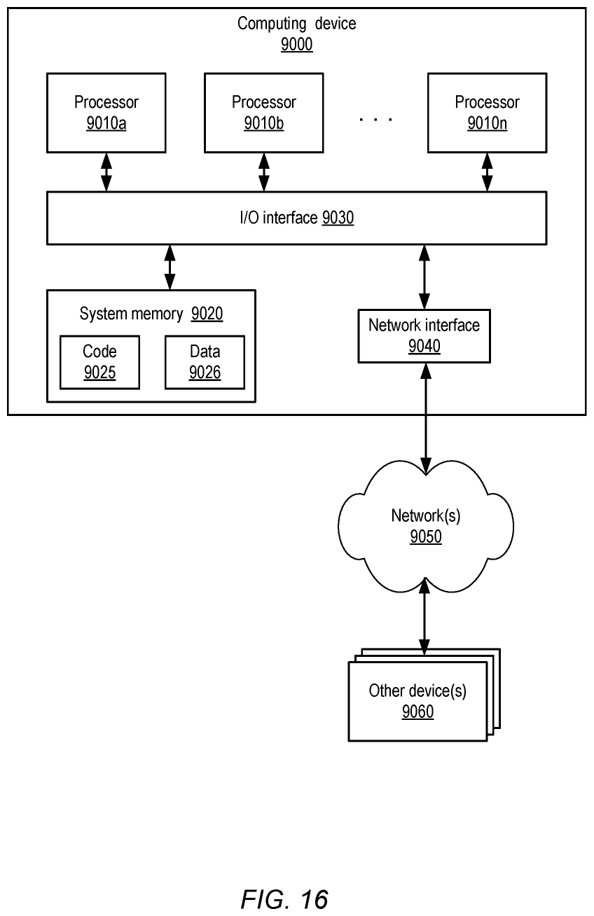

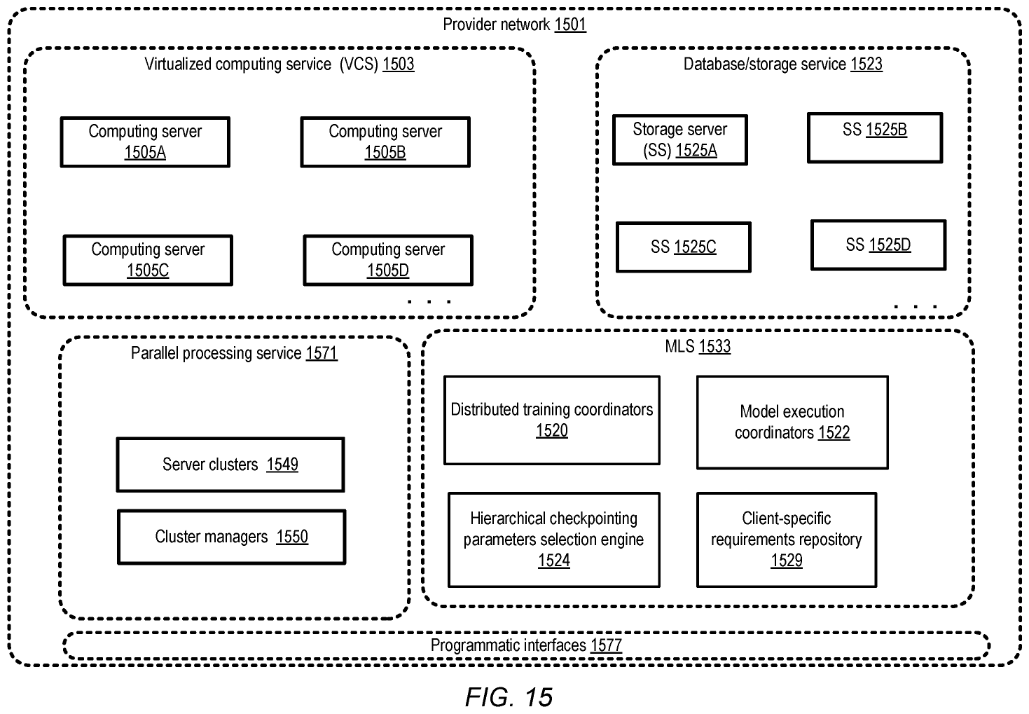

In at least one embodiment, as indicated above, at least a portion of an MLS at which a hierarchical checkpointing technique of the kind introduced above may be implemented at a provider network or cloud computing environment. FIG. 15 illustrates an example provider network at which a machine learning service may be implemented, according to at least some embodiments. In the depicted embodiment, provider network 1501 may comprise resources used to implement a plurality of network-accessible services, including for example a virtualized computing service (VCS) 1503, a database/storage service 1523, a parallel processing service 1571, as well as a an MLS 1533. The MLS, similar in features and functionality to MLS 102 of FIG. 1, may include several of the components discussed earlier, such as distributed training coordinators 1520, model execution coordinators 1522, hierarchical checkpointing parameters selectin engine 1524, and a client-specific requirements repository 1529 in the depicted embodiment.

The DTEs used for training large models on behalf of clients of the MLS may, for example comprise servers 1505 (e.g., 1505A, 1505B, 1505C or 1505D) of the VCS 1503 in the depicted embodiment. The checkpoints which are sent to remote persistent storage, as well as input data or outputs produced by some ML models, may be stored using storage servers of database/storage service 1523, such as SS 1525A, 1525B, 1525C or 1525D. In some cases, distributed training or distributed data pre-processing tasks for some ML models may be performed using server clusters 1549 of the parallel processing service 1571, with the execution of the parallel tasks being orchestrated with the help of cluster managers 1550 in the depicted embodiment. Components of a given service of a provider network may thus in general utilize components of other services in the depicted embodiment. Individual ones of the services shown in FIG. 15 may implement a respective set of programmatic interfaces 1577 which can be used by external and/or internal clients (where the internal clients may comprise components of other services) in the depicted embodiment. In at least some embodiments, resources of a cloud provider network may not be required for the kinds of techniques introduced above; instead, for example, a standalone set of resources may be used.

A cloud provider network can be formed as a number of regions, where a region is a separate geographical area in which the cloud provider clusters data centers. Such a region may also be referred to as a provider network-defined region, as its boundaries may not necessarily coincide with those of countries, states, etc. Each region can include two or more availability zones connected to one another via a private high speed network, for example a fiber communication connection. An availability zone (also known as an availability domain, or simply a “zone”) refers to an isolated failure domain including one or more data center facilities with separate power, separate networking, and separate cooling from those in another availability zone. A data center refers to a physical building or enclosure that houses and provides power and cooling to servers of the cloud provider network. Preferably, availability zones within a region are positioned far enough away from one other that the same natural disaster should not take more than one availability zone offline at the same time. Customers can connect to availability zones of the cloud provider network via a publicly accessible network (e.g., the Internet, a cellular communication network) by way of a transit center (TC). TCs can be considered as the primary backbone locations linking customers to the cloud provider network, and may be collocated at other network provider facilities (e.g., Internet service providers, telecommunications providers) and securely connected (e.g. via a VPN or direct connection) to the availability zones. Each region can operate two or more TCs for redundancy. Regions are connected to a global network connecting each region to at least one other region. The cloud provider network may deliver content from points of presence outside of, but networked with, these regions by way of edge locations and regional edge cache servers (points of presence, or PoPs). This compartmentalization and geographic distribution of computing hardware enables the cloud provider network to provide low-latency resource access to customers on a global scale with a high degree of fault tolerance and stability.

In some embodiments, an MLS may be implemented at least in part using an edge location of the provider network instead of or in addition to regional data centers. An edge location (or “edge zone”), as referred to herein, can be structured in several ways. In some implementations, an edge location can be an extension of the cloud provider network substrate including a limited quantity of capacity provided outside of an availability zone (e.g., in a small data center or other facility of the cloud provider that is located close to a customer workload and that may be distant from any availability zones). Such edge locations may be referred to as provider network extension sites or local zones (due to being more local or proximate to a group of users than traditional availability zones). A local zone may be connected in various ways to a publicly accessible network such as the Internet, for example directly, via another network, or via a private connection to a region. In some implementations, an edge location may be an extension of the cloud provider network substrate formed by one or more servers located on-premise in a customer or partner facility, wherein such server(s) communicate over a network (e.g., a publicly-accessible network such as the Internet) with a nearby availability zone or region of the cloud provider network. This type of substrate extension located outside of cloud provider network data centers can be referred to as an “outpost” of the cloud provider network.

A VCS of the cloud provider network may offer virtual compute instances (also referred to as virtual machines, or simply “instances”) with varying computational and/or memory resources in various embodiments, which may be used to implement components of an MLS or to perform distributed training of ML models. In one embodiment, each of the virtual compute instances may correspond to one of several instance types, families or categories, and instances of any of several families may be employed for computations of the MLS. An instance type may be characterized by its hardware type, computational resources (e.g., number, type, and configuration of central processing units (CPUs) or CPU cores, GPUs, or hardware accelerators for various tasks, including HTAs), memory resources (e.g., capacity, type, and configuration of local memory), storage resources (e.g., capacity, type, and configuration of locally accessible storage), network resources (e.g., characteristics of its network interface and/or network capabilities), and/or other suitable descriptive characteristics (such as being a “burstable” instance type that has a baseline performance guarantee and the ability to periodically burst above that baseline, a non-burstable or dedicated instance type that is allotted and guaranteed a fixed quantity of resources, or an instance type optimized for radio-based applications). Each instance type can have a specific ratio of processing, local storage, memory, and networking resources, and different instance families may have differing types of these resources as well. Multiple sizes of these resource configurations can be available within a given instance type. Using instance type selection functionality, an instance type may be selected for a customer, e.g., based (at least in part) on input from the customer. For example, a customer may choose an instance type from a predefined set of instance types. As another example, a customer may specify the desired resources of an instance type and/or requirements of a workload that the instance will run, and the instance type selection functionality may select an instance type based on such a specification. A suitable host for the requested instance type can be selected based at least partly on factors such as collected network performance metrics, resource utilization levels at different available hosts, and so on.

The traffic and operations of the cloud provider network, and individual services such as the MLS, may broadly be subdivided into two categories in various embodiments: control plane operations and data plane operations. While the data plane represents the movement of data through the distributed computing system, the control plane represents the movement of control signals through the distributed computing system. The control plane generally includes one or more control plane components distributed across and implemented by one or more control servers. Control plane traffic generally includes administrative operations, such as system configuration and management (e.g., resource placement, hardware capacity management, diagnostic monitoring, or system state information management). The data plane includes customer resources that are implemented on the cloud provider network (e.g., computing instances, containers, block storage volumes, databases, or file storage). Data plane traffic generally includes non-administrative operations such as transferring customer data to and from the customer resources. Certain control plane components (e.g., tier one control plane components such as the control plane for a virtualized computing service) are typically implemented on a separate set of servers from the data plane servers, while other control plane components (e.g., tier two control plane components such as analytics services) may share the virtualized servers with the data plane, and control plane traffic and data plane traffic may be sent over separate/distinct networks.

In at least some embodiments, a server that implements the types of techniques described herein (e.g., various functions of an MLS and/or other services of a provider network), may include a general-purpose computer system that includes or is configured to access one or more computer-accessible media. FIG. 16 illustrates such a general-purpose computing device 9000. In the illustrated embodiment, computing device 9000 includes one or more processors 9010 coupled to a system memory 9020 (which may comprise both non-volatile and volatile memory modules) via an input/output (I/O) interface 9030. Computing device 9000 further includes a network interface 9040 coupled to I/O interface 9030.

In various embodiments, computing device 9000 may be a uniprocessor system including one processor 9010, or a multiprocessor system including several processors 9010 (e.g., two, four, eight, or another suitable number). Processors 9010 may be any suitable processors capable of executing instructions. For example, in various embodiments, processors 9010 may be general-purpose or embedded processors implementing any of a variety of instruction set architectures (ISAs), such as the x86, PowerPC. SPARC, ARM, or MIPS ISAs, or any other suitable ISA. In multiprocessor systems, each of processors 9010 may commonly, but not necessarily, implement the same ISA. In some implementations, graphics processing units (GPUs) and or field-programmable gate arrays (FPGAs) may be used instead of, or in addition to, conventional processors.

System memory 9020 may be configured to store instructions and data accessible by processor(s) 9010. In at least some embodiments, the system memory 9020 may comprise both volatile and non-volatile portions; in other embodiments, only volatile memory may be used. In various embodiments, the volatile portion of system memory 9020 may be implemented using any suitable memory technology, such as static random access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 9020 as code 9025 and data 9026.

In one embodiment, I/O interface 9030 may be configured to coordinate I/O traffic between processor 9010, system memory 9020, and any peripheral devices in the device, including network interface 9040 or other peripheral interfaces such as various types of persistent and/or volatile storage devices. In some embodiments, I/O interface 9030 may perform any necessary protocol, timing or other data transformations to convert data signals from one component (e.g., system memory 9020) into a format suitable for use by another component (e.g., processor 9010). In some embodiments, I/O interface 9030 may include support for devices attached through various types of peripheral buses, such as a variant of the Peripheral Component Interconnect (PCI) bus standard or the Universal Serial Bus (USB) standard, for example. In some embodiments, the function of I/O interface 9030 may be split into two or more separate components, such as a north bridge and a south bridge, for example. Also, in some embodiments some or all of the functionality of I/O interface 9030, such as an interface to system memory 9020, may be incorporated directly into processor 9010.

Network interface 9040 may be configured to allow data to be exchanged between computing device 9000 and other devices 9060 attached to a network or networks 9050, such as other computer systems or devices as illustrated in FIG. 1 through FIG. 15, for example. In various embodiments, network interface 9040 may support communication via any suitable wired or wireless general data networks, such as types of Ethernet network, for example. Additionally, network interface 9040 may support communication via telecommunications/telephony networks such as analog voice networks or digital fiber communications networks, via storage area networks such as Fibre Channel SANs, or via any other suitable type of network and/or protocol.

In some embodiments, system memory 9020 may represent one embodiment of a computer-accessible medium configured to store at least a subset of program instructions and data used for implementing the methods and apparatus discussed in the context of FIG. 1 through FIG. 15. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 9000 via I/O interface 9030. A non-transitory computer-accessible storage medium may also include any volatile or non-volatile media such as RAM (e.g. SDRAM, DDR SDRAM, RDRAM, SRAM, etc.), ROM, etc., that may be included in some embodiments of computing device 9000 as system memory 9020 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 9040. Portions or all of multiple computing devices such as that illustrated in FIG. 16 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A system, comprising:
one or more computing devices;
wherein the one or more computing devices include instructions that upon execution on or across the one or more computing devices cause the one or computing devices to:
determine a number of training servers of a distributed training environment which is to be used to train a machine learning model, wherein an individual training server includes a main memory and one or more hardware training accelerators, wherein training of the machine learning model comprises a plurality of iterations, and wherein during an individual iteration, respective subsets of training state information of the machine learning model are generated at individual ones of the one or more hardware training accelerators;
determine a number of replicas of training state checkpoints of the machine learning model that are to be stored within respective main memories of training servers, wherein an individual training state checkpoint comprises training state information generated at the one or more hardware training accelerators of an individual training server;
generate, based at least in part on the number of replicas and the number of training servers of the distributed training environment, a placement plan for training state checkpoints, wherein the placement plan divides the training servers of the distributed training environment into groups, wherein an individual group includes a plurality of training servers, and wherein the placement plan indicates, with respect to a first training server within a particular group, one or more other training servers of the particular group at which respective replicas of training state checkpoints of the first training server are to be stored in main memory;
initiate training iterations of the machine learning model at the distributed training environment;
obtain a prediction of respective timings of one or more low-training-communication periods during training iterations of the machine learning model, wherein the prediction is based at least in part on analysis of network communications among a plurality of hardware training accelerators of the distributed training environment during selected training iterations of the machine learning model;
schedule, during predicted low-training-communication periods of one or more training iterations of the machine learning model, transmission of respective portions of replicas of training state checkpoints from the first training server of the particular group of training servers to a second training server of the particular group, wherein the second training server is selected based at least in part on the placement plan; and
resume, using at least a first replica of a first training state checkpoint which was generated at the first training server and transmitted to the second training server during the predicted low-training-communication periods, training iterations of the machine learning model after a first event results in a disruption of the training iterations.

2. The system of claim 1, wherein the one or more computing devices include further instructions that upon execution on or across the one or more computing devices further cause the one or computing devices to:
cause a second replica of a second training state checkpoint which was generated at the first training server to be stored in a main memory of the first training server; and
resume, using the second replica, training iterations of the machine learning model at the first training server after a second event results in a disruption of the training iterations.

3. The system of claim 1, wherein the one or more computing devices include further instructions that upon execution on or across the one or more computing devices further cause the one or computing devices to:
determine a rate at which replicas of training state checkpoints are to be transmitted from the first training server to a remote persistent storage device external to the first training server;
cause a second replica of a second training state checkpoint to be transmitted from the first training server to the remote persistent storage device in accordance with the rate; and
resume, using the second replica, training iterations of the machine learning model at the first training server after a second event results in a disruption of the training iterations.

4. The system of claim 1, wherein the first replica of the first training state checkpoint comprises one or more of: (a) respective values of learned parameters of the machine learning model or (b) optimizer states of the machine learning model.

5. The system of claim 1, wherein the one or more computing devices include further instructions that upon execution on or across the one or more computing devices further cause the one or computing devices to:
determine a rate at which replicas of training state checkpoints are to be transmitted between the first training server and the second training server, wherein in accordance with the rate, replicas of training state checkpoints are not transmitted between the first training server and the second training server during a subset of training iterations after the prediction is obtained.

6. A computer-implemented method, comprising:
determining a number of replicas of training state checkpoints of a machine learning model that are to be stored within respective main memories of training servers of a distributed training environment during training of the machine learning model, wherein individual training servers of the distributed training environment comprise one or more hardware training accelerators, wherein an individual training state checkpoint comprises training state information generated at the one or more hardware training accelerators of an individual training server, and wherein training of the machine learning model comprises a plurality of training iterations;
generating, based at least in part on the number of replicas, a placement plan for training state checkpoints, wherein the placement plan indicates, with respect to an individual training server, one or more other training servers of the distributed training environment at which respective replicas of training state checkpoints of the individual training server are to be stored in main memory;
transmitting, during predicted low-communication periods of one or more of the training iterations, respective portions of replicas of training state checkpoints from a first training server to a second training server, wherein the second training server is selected based at least in part on the placement plan; and
resuming training iterations of the machine learning model after a disruption of the training iterations, wherein said resuming comprises utilizing at least a first replica of a training state checkpoint which was generated at the first training server and transmitted to the second training server during the predicted low-communication periods.

7. The computer-implemented method of claim 6, further comprising:
predicting the low-communication periods based at least in part on analysis of network traffic between a plurality of hardware training accelerators of the distributed training environment.

8. The computer-implemented method of claim 6, further comprising:
storing, within main memory of the first training server, a second replica of a training state checkpoint of the first training server; and
utilizing the second replica to resume training iterations of the machine learning model subsequent to another disruption of the training iterations.

9. The computer-implemented method of claim 6, further comprising:
reserving a subset of accelerator memory of a particular hardware training accelerator of the first training server to store training state information which is to be transmitted to the second training server, wherein said transmitting the respective portions comprises transferring training state information from the subset to another hardware training accelerator of the second training server.

10. The computer-implemented method of claim 6, further comprising:
transmitting a particular portion of a particular replica of a training state checkpoint from the first training server to the second training server during a time interval which is not a predicted low-communication period.

11. The computer-implemented method of claim 6, further comprising:
storing, in a first portion of accelerator memory of a particular training accelerator of the second training server, a first portion of the first replica of the training state checkpoint which is transmitted from the first training server; and
copying, from a second portion of accelerator memory of the particular training accelerator, to another memory of the second training server, a second portion of the first replica, wherein said copying is performed at least partly in parallel with said storing the first portion of the first replica in the first portion of the accelerator memory.

12. The computer-implemented method of claim 6, further comprising:
storing a collection of training state information of the machine learning model at a storage service separate from the training servers of the distributed training environment, wherein the collection comprises contents of one or more training state checkpoints of one or more the training servers; and
subsequent to a particular failure detected at the distributed training environment, copying, from the storage service to one or more training servers of the distributed training environment, at least a portion of the collection to enable resumption of training iterations of the machine learning model.

13. The computer-implemented method of claim 6, further comprising:
obtaining, via one or more programmatic interfaces of a cloud computing environment, a set of parameters pertaining to training of the machine learning model, wherein the set of parameters include the number of training servers in the distributed training environment.

14. The computer-implemented method of claim 6, further comprising:
generating, at a cloud computing environment, one or more parameter recommendations pertaining to training of the machine learning model, wherein the one or more parameter recommendations includes the number of replicas; and
initiating training iterations of the machine learning model based at least in part on receiving approval of the one or more parameter recommendations.

15. The computer-implemented method of claim 6, wherein the first training server comprises a compute instance of a virtualized computing service of a cloud computing environment.

16. One or more non-transitory computer-accessible storage media storing program instructions that when executed on or across one or more processors cause the one or more processors to:
generate, based at least in part on a number of training servers of a distributed training environment of a machine learning model, a placement plan for training state checkpoints of the machine learning model, wherein the placement plan indicates, with respect to an individual training server, one or more other training servers at which respective replicas of training state checkpoints of the individual training server are to be stored;
transmit, during selected time periods of one or more training iterations of the machine learning model, respective portions of replicas of training state checkpoints from a first training server of a particular group of training servers to a second training server of the particular group, wherein the second training server is selected based at least in part on the placement plan; and
resume training iterations of the machine learning model after a first disruption of the training iterations, wherein resumption of the training iterations comprises retrieval of at least a particular replica of a training state checkpoint which was generated at the first training server and transmitted to the second training server during the selected time periods.

17. The one or more non-transitory computer-accessible storage media of claim 16, storing further program instructions that when executed on or across one or more processors further cause the one or more processors to:
select the time periods of the one or more training iterations based at least in part on analysis of network traffic between a plurality of hardware training accelerators of the distributed training environment.

18. The one or more non-transitory computer-accessible storage media of claim 16, storing further program instructions that when executed on or across one or more processors further cause the one or more processors to:
store, at the first training server, a local replica of a training state checkpoint of the first training server; and
utilize the local replica to resume training iterations of the machine learning model after a second disruption of the training iterations.

19. The one or more non-transitory computer-accessible storage media of claim 16, wherein the machine learning model comprises one or more neural networks.

20. The one or more non-transitory computer-accessible storage media of claim 16, wherein a particular hardware training accelerator of the first training server comprises one or more of: a graphics processing unit (GPU) or a processor customized for machine learning computations.
